(19) United States
(12) Patent Application Publication
(10) Pub. No.: US 2024/0389151 A1
(43) Pub. Date: Nov. 21, 2024

(54) COMMUNICATION METHOD AND COMMUNICATION APPARATUS

(71) Applicant: HUAWEI TECHNOLOGIES CO., LTD., Shenzhen (CN)

(72) Inventors: Hejia Luo, Hangzhou (CN); Xiaolu Wang, Hangzhou (CN); Yu Wang, Hangzhou (CN); Jun Wang, Hangzhou (CN)

(21) Appl. No.: 18/787,707

(22) Filed: Jul. 29, 2024

Related U.S. Application Data
(63) Continuation of application No. PCT/CN2023/072614, filed on Jan. 17, 2023.

(30) Foreign Application Priority Data
Jan. 30, 2022 (CN) 202210114383.X

(51) Int. Cl. H04W 74/0816; H04W 8/22; H04W 56/00; H04W 74/08

(52) U.S. Cl. CPC H04W 74/0816; H04W 8/22; H04W 56/0045; H04W 74/0891

(57) ABSTRACT

This application provides a communication method and a communication apparatus, to reduce TA error accumulation caused by an open-loop adjustment manner, reduce intersymbol interference of an uplink signal, and improve stability of a communication system. In the method, a terminal device receives and obtains first configuration information, where the first configuration information includes time domain information of a first transmission opportunity; the terminal device sends a first signal, where the first signal is used to determine TA information; the terminal device obtains the TA information; and the terminal device determines a TA between the terminal device and a network device based on the TA information, where the TA is used for data transmission after a time domain start location corresponding to the time domain information of the first transmission opportunity.

### CROSS-REFERENCE TO RELATED APPLICATIONS

This application is a continuation of International Application No. PCT/CN2023/072614, filed on Jan. 17, 2023, which claims priority to Chinese Patent Application No. 202210114383.X, filed on Jan. 30, 2022. The disclosures of the aforementioned applications are hereby incorporated by reference in their entireties.

### TECHNICAL FIELD

This application relates to the field of wireless technologies, and in particular, to a communication method and a communication apparatus.

### BACKGROUND

In a wireless communication process, due to a transmission delay, to ensure orthogonal transmission of uplink signals of a plurality of terminal devices, the terminal devices need to send the uplink signals based on different timing advance (timing advance, TA) information. This process is referred to as uplink timing advancing. Generally, the terminal device may update a TA based on an indication of a network device. This manner may also be referred to as a closed-loop adjustment manner.

Currently, in a satellite communication scenario, a satellite is used as a network device. Because the satellite moves at a high speed, the TA may change rapidly, and the closed-loop adjustment manner easily causes large overheads. Therefore, currently, a manner of combining open-loop adjustment and closed-loop adjustment is proposed to reduce overheads of closed-loop adjustment. For example, a manner in which the terminal device performs TA adjustment based on a historical change rate of the TA at an interval between two times of closed-loop TA adjustment may be referred to as an open-loop adjustment manner. In this way, the interval between the two times of closed-loop TA adjustment can be appropriately prolonged.

In addition, in a system based on beam communication, a terminal device in an area covered by a communication beam of a satellite may communicate with the satellite. In other words, if a terminal device is located in the area covered by the communication beam of the satellite, the terminal device has a transmission opportunity to communicate with the satellite, and may perform uplink/downlink data transmission. Because there are a large quantity of beams that need to be scanned in a signal coverage area of the satellite, and a quantity of beams that can be used by the satellite for communication at a moment is limited, beams used for communication between the satellite and a terminal device in the signal coverage area of the satellite are discontinuous, in other words, transmission opportunities of the terminal device are discontinuous.

However, due to a limitation of processing precision of the terminal device, the long-time open-loop adjustment manner causes TA error accumulation. When the transmission opportunities of the terminal device are discontinuous, because resource information between different transmission opportunities may not be completely the same, TA error accumulation is more serious, and intersymbol interference of the uplink signal is easily caused.

### SUMMARY

This application provides a communication method and a communication apparatus. When transmission opportunities of a terminal device are discontinuous, the terminal device performs, after a time domain start location corresponding to time domain information of the transmission opportunity, data transmission with a network device based on a TA determined based on TA information, to reduce TA error accumulation caused by an open-loop adjustment manner, reduce intersymbol interference of an uplink signal, and improve stability of a communication system.

A first aspect of this application provides a communication method. The method is performed by a terminal device, or the method is performed by some components (for example, a processor, a chip, or a chip system) in the terminal device, or the method may be implemented by a logical module or software that can implement all or some functions of the terminal device. In the first aspect and possible implementations of the first aspect, an example in which the communication method is performed by the terminal device is used for description. In the method, the terminal device receives first configuration information from a network device, where the first configuration information includes time domain information of a first transmission opportunity; the terminal device sends a first signal to the network device, where the first signal is used to determine TA information; the terminal device receives the TA information from the network device; and the terminal device determines a TA between the terminal device and the network device based on the TA information, where the TA is used for data transmission after a time domain start location corresponding to the time domain information of the first transmission opportunity.

Based on the foregoing technical solution, the terminal device sends, before the time domain start location corresponding to the time domain information of the first transmission opportunity, the first signal used to determine the TA information. In addition, after the terminal device receives the TA information, the terminal device determines the TA between the terminal device and the network device based on the TA information, where the TA is used for data transmission after the time domain start location corresponding to the time domain information of the first transmission opportunity. In other words, after the time domain start location corresponding to the time domain information of the first transmission opportunity, the terminal device communicates with the network device based on the TA determined based on the TA information. Therefore, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

It should be noted that the “transmission opportunity” in this application may be replaced with a “hopping beam”.

In a possible implementation of the first aspect, frequency domain information that carries the first signal is the same as frequency domain information of the first transmission opportunity; and/or polarization information corresponding to the first signal is the same as polarization information corresponding to the first transmission opportunity.

Based on the foregoing technical solution, resource information (including frequency domain information and/or polarization information) corresponding to different transmission opportunities may be different. Therefore, when resource information corresponding to the first signal sent before the time domain start location corresponding to the time domain information of the first transmission opportunity is the same as that corresponding to the first transmission opportunity, a probability that the first signal is received by the network device can be increased.

Optionally, the frequency domain information that carries the first signal is different from the frequency domain information of the first transmission opportunity; and/or the polarization information corresponding to the first signal is different from the polarization information corresponding to the first transmission opportunity.

In a possible implementation of the first aspect, before the terminal device sends the first signal, the method further includes: The terminal device receives second configuration information from the network device, where the second configuration information includes time domain information that carries the first signal.

Based on the foregoing technical solution, before the terminal device sends the first signal, the terminal device may further receive, from the network device, the second configuration information that includes the time domain information that carries the first signal, so that the terminal device determines the time domain information corresponding to the first signal, and another configuration that is related to the first signal and that may be further included in the second configuration information.

In a possible implementation of the first aspect, the time domain information that carries the first signal includes a first parameter, and the first parameter is associated with a time interval between different transmission opportunities.

Based on the foregoing technical solution, the time domain information that carries the first signal includes the first parameter, and the first parameter is associated with the time interval between the different transmission opportunities, so that the terminal device sends the first signal based on the first parameter at (or before) a time domain start location corresponding to a next transmission opportunity, and the terminal device receives, from the network device at (or after) the time domain start location corresponding to the next transmission opportunity, the TA information determined based on the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

In a possible implementation of the first aspect, before the terminal device receives the second configuration information from the network device, the method further includes: The terminal device sends first capability information to the network device, where the first capability information indicates a TA time synchronization capability of the terminal device.

Based on the foregoing technical solution, the terminal device may further send the first capability information indicating the TA time synchronization capability of the terminal device, so that the network device can determine, based on the first capability information, whether the terminal device needs to enable closed-loop TA adjustment related to a transmission opportunity, and when the network device determines that closed-loop TA adjustment related to the transmission opportunity needs to be enabled, the network device sends, to the terminal device, the second configuration information corresponding to the first signal.

In a possible implementation of the first aspect, the second configuration information further includes at least one of a generation parameter of the first signal, frequency domain information that carries the first signal, and polarization information corresponding to the first signal.

In a possible implementation of the first aspect, that the terminal device determines the TA between the terminal device and the network device based on the TA information includes: After the terminal device determines that a difference between a time domain location corresponding to the time domain information of the first transmission opportunity and a time domain location corresponding to time domain information of a second transmission opportunity is greater than a threshold, the terminal device determines the TA between the terminal device and the network device based on the TA information, where the second transmission opportunity is a transmission opportunity at an adjacent time domain location of the first transmission opportunity.

It should be understood that, in time domain, the time domain location corresponding to the second transmission opportunity is before the time domain location corresponding to the first transmission opportunity; or the time domain location corresponding to the second transmission opportunity is after the time domain location corresponding to the first transmission opportunity.

Based on the foregoing technical solution, after the terminal device determines that the difference between the time domain location corresponding to the time domain information of the first transmission opportunity and the time domain location corresponding to the time domain information of the second transmission opportunity is greater than the threshold, the terminal device determines that a time interval between the first transmission opportunity and an adjacent transmission opportunity is long. If closed-loop TA adjustment is not performed, TA error accumulation may be serious. Therefore, the terminal device may determine the TA between the terminal device and the network device based on the TA information, that is, the terminal device performs closed-loop TA adjustment.

Optionally, after the terminal device determines that the difference between the time domain location corresponding to the time domain information of the first transmission opportunity and the time domain location corresponding to the time domain information of the second transmission opportunity is equal to the threshold, the terminal device determines the TA between the terminal device and the network device based on the TA information.

Optionally, after the terminal device determines that the difference between the time domain location corresponding to the time domain information of the first transmission opportunity and the time domain location corresponding to the time domain information of the second transmission opportunity is less than or equal to the threshold, the terminal device does not need to determine the TA between the terminal device and the network device based on the TA information.

In a possible implementation of the first aspect, before the terminal device sends the first signal to the network device, the method further includes: The terminal device receives first indication information from the network device, where the first indication information indicates a first time period; and when the terminal device determines that a current moment falls within the first time period, the terminal device sends the first signal to the network device.

Based on the foregoing technical solution, when the terminal device determines that the current moment falls within the first time period indicated by the network device by using the first indication information, the terminal device determines that closed-loop TA adjustment needs to be performed based on an indication of the network device. In other words, the terminal device sends the first signal to the network device, to obtain the TA information used to determine the TA between the terminal device and the network device.

Optionally, when the terminal device determines that the current moment does not fall within the first time period, the terminal device does not need to send the first signal to the network device.

In a possible implementation of the first aspect, that the terminal device sends the first signal to the network device includes: The terminal device sends the first signal to the network device before an offset before the time domain start location.

Based on the foregoing technical solution, to ensure that the terminal device performs, after a time domain start location corresponding to time domain information of a transmission opportunity, data transmission with the network device based on the TA determined based on the TA information, the terminal device needs to send, in advance, the first signal used to determine the TA information. In other words, the terminal device needs to send the first signal before the offset before the time domain start location.

In a possible implementation of the first aspect, the method further includes: The terminal device receives second indication information from the network device, where the second indication information indicates the offset.

Based on the foregoing technical solution, before the terminal device sends the first signal, the terminal device further receives the second indication information indicating the offset, so that the terminal device determines, based on the offset, a time domain location for sending the first signal.

Optionally, the offset is preconfigured in the terminal device.

A second aspect of this application provides a communication method. The method is performed by a network device, or the method is performed by some components (for example, a processor, a chip, or a chip system) in the network device, or the method may be implemented by a logical module or software that can implement all or some functions of the network device. In the second aspect and possible implementations of the second aspect, an example in which the communication method is performed by the network device is used for description. In the method, the network device sends first configuration information to a terminal device, where the first configuration information includes time domain information of a first transmission opportunity; the network device receives a first signal from the terminal device, where the first signal is used to determine timing advance TA information; and the network device sends the TA information to the terminal device, where the TA information is used to determine a TA between the terminal device and the network device, and the TA is used for data transmission after a time domain start location corresponding to the time domain information of the first transmission opportunity.

Based on the foregoing technical solution, after the network device receives, before the time domain start location corresponding to the time domain information of the first transmission opportunity, the first signal used to determine the TA information, the network device determines and sends the TA information, so that the terminal device determines the TA between the terminal device and the network device based on the TA information, where the TA is used for data transmission after the time domain start location corresponding to the time domain information of the first transmission opportunity. In other words, after the time domain start location corresponding to the time domain information of the first transmission opportunity, the network device communicates with the terminal device based on the TA determined based on the TA information. Therefore, when transmission opportunities of the terminal device are discontinuous, the network device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

In a possible implementation of the second aspect, frequency domain information that carries the first signal is the same as frequency domain information of the first transmission opportunity; and/or polarization information corresponding to the first signal is the same as polarization information corresponding to the first transmission opportunity.

Based on the foregoing technical solution, resource information (including frequency domain information and/or polarization information) corresponding to different transmission opportunities may be different. Therefore, when resource information corresponding to the first signal sent before the time domain start location corresponding to the time domain information of the first transmission opportunity is the same as that corresponding to the first transmission opportunity, a probability that the first signal is received by the network device can be increased.

Optionally, the frequency domain information that carries the first signal is different from the frequency domain information of the first transmission opportunity; and/or the polarization information corresponding to the first signal is different from the polarization information corresponding to the first transmission opportunity.

In a possible implementation of the second aspect, before the network device receives the first signal from the terminal device, the method further includes: The network device sends second configuration information to the terminal device, where the second configuration information includes time domain information that carries the first signal.

Based on the foregoing technical solution, before the terminal device sends the first signal, the network device may further send the second configuration information that includes the time domain information that carries the first signal, so that the terminal device determines the time domain information corresponding to the first signal, and another configuration that is related to the first signal and that may be further included in the second configuration information.

In a possible implementation of the second aspect, the time domain information that carries the first signal includes a first parameter, and the first parameter is associated with a time interval between different transmission opportunities.

Based on the foregoing technical solution, the time domain information that carries the first signal includes the first parameter, and the first parameter is associated with the time interval between the different transmission opportunities, so that the terminal device sends the first signal based on the first parameter at (or before) a time domain start location corresponding to a next transmission opportunity, and the terminal device receives, from the network device at (or after) the time domain start location corresponding to the next transmission opportunity, the TA information determined based on the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

In a possible implementation of the second aspect, that the network device sends the second configuration information to the terminal device includes: The network device receives first capability information from the terminal device, where the first capability information indicates a TA time synchronization capability of the terminal device; and the network device sends the second configuration information to the terminal device based on the first capability information.

Based on the foregoing technical solution, the terminal device may further send the first capability information indicating the TA time synchronization capability of the terminal device, so that the network device can determine, based on the first capability information, whether the terminal device needs to enable closed-loop TA adjustment related to a transmission opportunity, and when the network device determines that closed-loop TA adjustment related to the transmission opportunity needs to be enabled, the network device sends, to the terminal device, the second configuration information corresponding to the first signal.

In a possible implementation of the first aspect, the second configuration information further includes at least one of a generation parameter of the first signal, frequency domain information that carries the first signal, and polarization information corresponding to the first signal.

In a possible implementation of the second aspect, before the network device receives the first signal from the terminal device, the method further includes: The network device sends first indication information to the terminal device, where the first indication information indicates a first time period.

Based on the foregoing technical solution, the network device may further send, to the terminal device, the first indication information indicating the first time period, so that when the terminal device determines that a current moment falls within the first time period, the terminal device determines that closed-loop TA adjustment needs to be performed based on an indication of the network device. In other words, the terminal device sends the first signal to the network device, to obtain the TA information used to determine the TA between the terminal device and the network device.

In a possible implementation of the second aspect, that the network device receives the first signal from the terminal device includes: The network device receives the first signal from the terminal device before an offset before the time domain start location.

Based on the foregoing technical solution, to ensure that the terminal device performs, after a time domain start location corresponding to time domain information of a transmission opportunity, data transmission with the network device based on the TA determined based on the TA information, the terminal device needs to send, in advance, the first signal used to determine the TA information. In other words, the terminal device needs to send the first signal before the offset before the time domain start location.

In a possible implementation of the second aspect, the method further includes: The network device sends second indication information to the terminal device, where the second indication information indicates the offset.

Based on the foregoing technical solution, before the terminal device sends the first signal, the terminal device further receives the second indication information indicating the offset, so that the terminal device determines, based on the offset, a time domain location for sending the first signal.

Optionally, the offset is preconfigured in the terminal device.

In a possible implementation of the first aspect or the second aspect, that the network device sends the TA information to the terminal device includes: The network device determines a difference between a time domain location corresponding to the time domain information of the first transmission opportunity and a time domain location corresponding to time domain information of a second transmission opportunity, where the second transmission opportunity is a transmission opportunity at an adjacent time domain location of the first transmission opportunity; and when the network device determines that the difference is greater than a threshold, the network device sends the TA information.

Based on the foregoing technical solution, after the network device determines that the difference between the time domain location corresponding to the time domain information of the first transmission opportunity and the time domain location corresponding to the time domain information of the second transmission opportunity is greater than the threshold, the network device determines that a time interval between the first transmission opportunity and an adjacent transmission opportunity is long. If closed-loop TA adjustment is not performed, TA error accumulation may be serious. Therefore, the network device may send the TA information, so that the terminal device can determine the TA between the terminal device and the network device based on the TA information, that is, the terminal device performs closed-loop TA adjustment.

Optionally, when the network device determines that the difference is equal to the threshold, the network device sends the TA information.

Optionally, when the network device determines that the difference is less than or equal to the threshold, the network device does not need to send the TA information.

In a possible implementation of the first aspect or the second aspect, the difference between the time domain location corresponding to the time domain information of the first transmission opportunity and the time domain location corresponding to the time domain information of the second transmission opportunity includes any one of the following: a difference between a start moment of the time domain location corresponding to the time domain information of the first transmission opportunity and a start moment of the time domain location corresponding to the time domain information of the second transmission opportunity; a difference between an end moment of the time domain location corresponding to the time domain information of the first transmission opportunity and an end moment of the time domain location corresponding to the time domain information of the second transmission opportunity; a difference between an end moment of the time domain location corresponding to the time domain information of the first transmission opportunity and a start moment of the time domain location corresponding to the time domain information of the second transmission opportunity; or a difference between a start moment of the time domain location corresponding to the time domain information of the first transmission opportunity and an end moment of the time domain location corresponding to the time domain information of the second transmission opportunity.

Based on the foregoing technical solution, the difference between the time domain location corresponding to the time domain information of the first transmission opportunity and the time domain location corresponding to the time domain information of the second transmission opportunity may be determined in the foregoing plurality of manners, to improve flexibility of implementing the solution.

In a possible implementation of the first aspect or the second aspect, the first configuration information further includes at least one of frequency domain information of the first transmission opportunity and polarization information of the first transmission opportunity.

Based on the foregoing technical solution, the first configuration information may further include at least one of the frequency domain information of the first transmission opportunity and the polarization information of the first transmission opportunity, so that the terminal device further determines, based on the first configuration information, resource information corresponding to the first transmission opportunity.

In a possible implementation of the first aspect or the second aspect, the first indication information includes at least one of a start moment of the first time period, an end moment of the first time period, and duration of the first time period.

In a possible implementation of the first aspect or the second aspect, the first signal includes an SRS or a preamble (preamble).

A third aspect of this application provides a communication method. The method is performed by a terminal device, or the method is performed by some components (for example, a processor, a chip, or a chip system) in the terminal device, or the method may be implemented by a logical module or software that can implement all or some functions of the terminal device. In the third aspect and possible implementations of the third aspect, an example in which the communication method is performed by the terminal device is used for description. In the method, the terminal device determines first capability information, where the first capability information indicates a TA time synchronization capability of the terminal device; and the terminal device sends the first capability information.

Based on the foregoing technical solution, the first capability information sent by the terminal device indicates the TA time synchronization capability of the terminal device, so that a network device can determine the TA time synchronization capability of the terminal device based on the first capability information. In other words, the network device may determine capability information of open-loop TA adjustment of the terminal device based on the first capability information. In other words, the network device may use the first capability information as one of bases for whether scheduling the terminal device to perform closed-loop TA adjustment. Therefore, the network device can subsequently use information about the TA time synchronization capability sent by the terminal device as one of scheduling bases for closed-loop TA adjustment, to reduce overheads caused by performing closed-loop TA adjustment by a terminal device with a strong TA time synchronization capability, and enable a terminal device with a weak TA time synchronization capability to perform closed-loop TA adjustment in time.

In a possible implementation of the third aspect, the method further includes: The terminal device receives second configuration information from a first network device, where the second configuration information includes time domain information that carries a first signal; the terminal device sends the first signal based on the second configuration information, where the first signal is used to determine TA information; the terminal device receives the TA information from the network device; and the terminal device determines a TA between the terminal device and the network device based on the TA information, where the TA is used for data transmission after a time domain start location corresponding to time domain information of a first transmission opportunity.

Based on the foregoing technical solution, the terminal device may further receive the TA information from the network device, and determine the TA between the terminal device and the network device based on the TA information, where the TA is used for data transmission after the time domain start location corresponding to the time domain information of the first transmission opportunity. In other words, after the time domain start location corresponding to the time domain information of the first transmission opportunity, the terminal device communicates with the network device based on the TA determined based on the TA information. Therefore, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

A fourth aspect of this application provides a communication method. The method is performed by a network device, or the method is performed by some components (for example, a processor, a chip, or a chip system) in the network device, or the method may be implemented by a logical module or software that can implement all or some functions of the network device. In the fourth aspect and possible implementations of the fourth aspect, an example in which the communication method is performed by the network device is used for description. In the method, a first network device receives first capability information from a terminal device, where the first capability information indicates a TA tracking capability of the terminal device; the first network device sends second configuration information to the terminal device based on the first capability information, where the second configuration information includes time domain information that carries a first signal; the network device receives the first signal, where the first signal is used to determine TA information; and the network device sends the TA information, where the TA information is used to determine a TA between the terminal device and the network device, and the TA is used for data transmission after a time domain start location corresponding to time domain information of a first transmission opportunity.

Based on the foregoing technical solution, the first capability information sent by the terminal device indicates the TA time synchronization capability of the terminal device, so that the network device can determine the TA time synchronization capability of the terminal device based on the first capability information. In other words, the network device may determine capability information of open-loop TA adjustment of the terminal device based on the first capability information. In other words, the network device may use the first capability information as one of bases for whether scheduling the terminal device to perform closed-loop TA adjustment. Therefore, the network device can subsequently use information about the TA time synchronization capability sent by the terminal device as one of scheduling bases for closed-loop TA adjustment, to reduce overheads caused by performing closed-loop TA adjustment by a terminal device with a strong TA time synchronization capability, and enable a terminal device with a weak TA time synchronization capability to perform closed-loop TA adjustment in time.

In a possible implementation of the fourth aspect, the method further includes: The first network device sends the first capability information to a second network device.

Based on the foregoing technical solution, the first network device may further send, to the second network device, the first capability information indicating the TA tracking capability of the terminal device. In other words, the information about the TA time synchronization capability of the terminal device may be transmitted between different network devices, so that after the terminal device is handed over to another network device, the another network device can also obtain corresponding capability information.

In a possible implementation of the third aspect or the fourth aspect, the first signal includes an SRS or a preamble (preamble).

A fifth aspect of this application provides a communication method. The method is performed by a terminal device, or the method is performed by some components (for example, a processor, a chip, or a chip system) in the terminal device, or the method may be implemented by a logical module or software that can implement all or some functions of the terminal device. In the fifth aspect and possible implementations of the fifth aspect, an example in which the communication method is performed by the terminal device is used for description. In the method, the terminal device receives second configuration information, where the second configuration information includes time domain information that carries a first signal, the first signal is used to determine timing advance TA information, the time domain information that carries the first signal includes a first parameter, and the first parameter is associated with a time interval between different transmission opportunities; and the terminal device sends the first signal based on the second configuration information.

Based on the foregoing technical solution, the second configuration information received by the terminal device includes the time domain information that carries the first signal, and the time domain information that carries the first signal includes the first parameter associated with the time interval between the different transmission opportunities, so that the terminal device sends the first signal based on the second configuration information. The first parameter may enable a network device to schedule the first signal within coverage time of a transmission opportunity, and enable time at which the terminal device actually sends the first signal to be slightly earlier than coverage time of a next transmission opportunity. Therefore, closed-loop TA adjustment of the terminal device is completed at (or before) a time domain start location of the next transmission opportunity, and after a time domain start location corresponding to time domain information of a first transmission opportunity, the terminal device communicates with the network device based on a TA determined based on the TA information. In other words, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

A sixth aspect of this application provides a communication method. The method is performed by a network device, or the method is performed by some components (for example, a processor, a chip, or a chip system) in the network device, or the method may be implemented by a logical module or software that can implement all or some functions of the network device. In the sixth aspect and possible implementations of the sixth aspect, an example in which the communication method is performed by the network device is used for description. In the method, the network device sends second configuration information, where the second configuration information includes time domain information that carries a first signal, the first signal is used to determine timing advance TA information, the time domain information that carries the first signal includes a first parameter, and the first parameter is associated with a time interval between different transmission opportunities; and the network device receives the first signal.

Based on the foregoing technical solution, the second configuration information sent by the network device includes the time domain information that carries the first signal, and the time domain information that carries the first signal includes the first parameter associated with the time interval between the different transmission opportunities, so that a terminal device sends the first signal based on the second configuration information. The first parameter may enable the network device to schedule the first signal within coverage time of a transmission opportunity, and enable time at which the terminal device actually sends the first signal to be slightly earlier than coverage time of a next transmission opportunity. Therefore, closed-loop TA adjustment of the terminal device is completed at (or before) a time domain start location of the next transmission opportunity, and after a time domain start location corresponding to time domain information of a first transmission opportunity, the terminal device communicates with the network device based on a TA determined based on the TA information. In other words, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

In a possible implementation of the fifth aspect or the sixth aspect, the first signal includes an SRS or a preamble (preamble).

A seventh aspect of this application provides a communication apparatus. The apparatus may implement the method in any one of the first aspect or the possible implementations of the first aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the terminal device, or the apparatus may be a logical module or software that can implement all or some functions of the terminal device.

The apparatus includes a processing unit and a transceiver unit.

The transceiver unit is configured to obtain first configuration information, where the first configuration information includes time domain information of a first transmission opportunity.

The transceiver unit is further configured to send a first signal, where the first signal is used to determine timing advance TA information.

The transceiver unit is further configured to obtain the TA information.

The processing unit is configured to determine a TA between the terminal device and a network device based on the TA information, where the TA is used for data transmission after a time domain start location corresponding to the time domain information of the first transmission opportunity.

In a possible implementation of the seventh aspect, the transceiver unit is further configured to obtain second configuration information, where the second configuration information includes time domain information that carries the first signal.

In a possible implementation of the seventh aspect, the transceiver unit is further configured to send first capability information, where the first capability information indicates a TA time synchronization capability of the terminal device.

In a possible implementation of the seventh aspect, the processing unit is specifically configured to:
after determining that a difference between a time domain location corresponding to the time domain information of the first transmission opportunity and a time domain location corresponding to time domain information of a second transmission opportunity is greater than a threshold, determine the TA between the terminal device and the network device based on the TA information, where
the second transmission opportunity is a transmission opportunity at an adjacent time domain location of the first transmission opportunity.

In a possible implementation of the seventh aspect,
the transceiver unit is further configured to obtain first indication information, where the first indication information indicates a first time period.

When the processing unit determines that a current moment falls within the first time period, the transceiver unit sends the first signal.

In the seventh aspect of embodiments of this application, the composition modules of the communication apparatus may be further configured to: perform the steps performed in the possible implementations of the first aspect, and implement corresponding technical effects. For details, refer to the first aspect. Details are not described herein again.

An eighth aspect of this application provides a communication apparatus. The apparatus may implement the method in any one of the second aspect or the possible implementations of the second aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the network device, or the apparatus may be a logical module or software that can implement all or some functions of the network device.

The apparatus includes a processing unit and a transceiver unit.

The transceiver unit is configured to send first configuration information, where the first configuration information includes time domain information of a first transmission opportunity.

The transceiver unit is further configured to obtain a first signal, where the first signal is used to determine timing advance TA information.

The processing unit is configured to determine the TA information based on the first signal.

The transceiver unit is further configured to send the TA information, where the TA information is used to determine a TA between a terminal device and the network device, and the TA is used for data transmission after a time domain start location corresponding to the time domain information of the first transmission opportunity.

In a possible implementation of the eighth aspect, the transceiver unit is further configured to send second configuration information, where the second configuration information includes time domain information that carries the first signal.

In a possible implementation of the eighth aspect, the transceiver unit is further configured to obtain first capability information, where the first capability information indicates a TA time synchronization capability of the terminal device.

The transceiver unit is further configured to send the second configuration information based on the first capability information.

In a possible implementation of the eighth aspect, the transceiver unit is further configured to send first indication information, where the first indication information indicates a first time period.

In a possible implementation of the eighth aspect,
the processing unit is further configured to determine a difference between a time domain location corresponding to the time domain information of the first transmission opportunity and a time domain location corresponding to time domain information of a second transmission opportunity, where the second transmission opportunity is a transmission opportunity at an adjacent time domain location of the first transmission opportunity.

When the processing unit determines that the difference is greater than a threshold, the transceiver unit sends the TA information.

In a possible implementation of the seventh aspect or the eighth aspect, the difference between the time domain location corresponding to the time domain information of the first transmission opportunity and the time domain location corresponding to the time domain information of the second transmission opportunity includes any one of the following:
a difference between a start moment of the time domain location corresponding to the time domain information of the first transmission opportunity and a start moment of the time domain location corresponding to the time domain information of the second transmission opportunity;
a difference between an end moment of the time domain location corresponding to the time domain information of the first transmission opportunity and an end moment of the time domain location corresponding to the time domain information of the second transmission opportunity;
a difference between an end moment of the time domain location corresponding to the time domain information of the first transmission opportunity and a start moment of the time domain location corresponding to the time domain information of the second transmission opportunity; or
a difference between a start moment of the time domain location corresponding to the time domain information of the first transmission opportunity and an end moment of the time domain location corresponding to the time domain information of the second transmission opportunity.

In a possible implementation of the seventh aspect or the eighth aspect, the first configuration information further includes at least one of frequency domain information of the first transmission opportunity and polarization information of the first transmission opportunity.

In a possible implementation of the seventh aspect or the eighth aspect, the first indication information includes at least one of a start moment of the first time period, an end moment of the first time period, and duration of the first time period.

In a possible implementation of the seventh aspect or the eighth aspect, the first signal includes a sounding reference signal SRS or a preamble preamble.

In the eighth aspect of embodiments of this application, the composition modules of the communication apparatus may be further configured to: perform the steps performed in the possible implementations of the second aspect, and implement corresponding technical effects. For details, refer to the second aspect. Details are not described herein again.

A ninth aspect of this application provides a communication apparatus. The apparatus may implement the method in any one of the third aspect or the possible implementations of the third aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the terminal device, or the apparatus may be a logical module or software that can implement all or some functions of the terminal device.

The apparatus includes a processing unit and a transceiver unit.

The processing unit is configured to determine first capability information, where the first capability information indicates a TA time synchronization capability of the terminal device.

The transceiver unit is configured to send the first capability information.

In a possible implementation of the ninth aspect,
the transceiver unit is further configured to obtain second configuration information, where the second configuration information includes time domain information that carries a first signal.

The transceiver unit is further configured to send the first signal based on the second configuration information, where the first signal is used to determine TA information.

The transceiver unit is further configured to obtain the TA information.

The processing unit is further configured to determine a TA between the terminal device and a network device based on the TA information, where the TA is used for data transmission after a time domain start location corresponding to time domain information of a first transmission opportunity.

In the ninth aspect of embodiments of this application, the composition modules of the communication apparatus may be further configured to: perform the steps performed in the possible implementations of the third aspect, and implement corresponding technical effects. For details, refer to the third aspect. Details are not described herein again.

A tenth aspect of this application provides a communication apparatus. The apparatus may implement the method in any one of the fourth aspect or the possible implementations of the fourth aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the network device, or the apparatus may be a logical module or software that can implement all or some functions of the network device.

The apparatus includes a processing unit and a transceiver unit.

The transceiver unit is configured to obtain first capability information, where the first capability information indicates a TA tracking capability of a terminal device.

The transceiver unit is further configured to send second configuration information based on the first capability information, where the second configuration information includes time domain information that carries a first signal.

The transceiver unit is further configured to obtain the first signal based on the second configuration information, where the first signal is used to determine TA information.

The processing unit is configured to determine the TA information, where the TA information is used to determine a TA between the terminal device and the network device.

The transceiver unit is further configured to send the TA information.

In a possible implementation of the tenth aspect,
the transceiver unit is further configured to send the first capability information.

In the tenth aspect of embodiments of this application, the composition modules of the communication apparatus may be further configured to: perform the steps performed in the possible implementations of the fourth aspect, and implement corresponding technical effects. For details, refer to the fourth aspect. Details are not described herein again.

An eleventh aspect of this application provides a communication apparatus. The apparatus may implement the method in any one of the fifth aspect or the possible implementations of the fifth aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the terminal device, or the apparatus may be a logical module or software that can implement all or some functions of the terminal device.

The apparatus includes a processing unit and a transceiver unit.

The transceiver unit is configured to obtain second configuration information, where the second configuration information includes time domain information that carries a first signal, the first signal is used to determine timing advance TA information, the time domain information that carries the first signal includes a first parameter, and the first parameter is associated with a time interval between different transmission opportunities.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and a network device.

The processing unit is configured to determine the first signal based on the second configuration information.

The transceiver unit is further configured to send the first signal.

In the eleventh aspect of embodiments of this application, the composition modules of the communication apparatus may be further configured to: perform the steps performed in the possible implementations of the fifth aspect, and implement corresponding technical effects. For details, refer to the fifth aspect. Details are not described herein again.

A twelfth aspect of this application provides a communication apparatus. The apparatus may implement the method in any one of the sixth aspect or the possible implementations of the sixth aspect. The apparatus includes a corresponding unit or module configured to perform the method. The unit or the module included in the apparatus may be implemented by software and/or hardware. For example, the apparatus may be a terminal device, or the apparatus may be a component (for example, a processor, a chip, or a chip system) in the network device, or the apparatus may be a logical module or software that can implement all or some functions of the network device.

The apparatus includes a processing unit and a transceiver unit.

The processing unit is configured to determine second configuration information, where the second configuration information includes time domain information that carries a first signal, and the first signal is used to determine timing advance TA information.

The transceiver unit is configured to send the second configuration information, where the time domain information that carries the first signal includes a first parameter, and the first parameter is associated with a time interval between different transmission opportunities.

The transceiver unit is further configured to receive the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between a terminal device and the network device.

In the twelfth aspect of embodiments of this application, the composition modules of the communication apparatus may be further configured to: perform the steps performed in the possible implementations of the sixth aspect, and implement corresponding technical effects. For details, refer to the sixth aspect. Details are not described herein again.

A thirteenth aspect of embodiments of this application provides a communication apparatus, including at least one processor. The at least one processor is coupled to a memory.

The memory is configured to store a program or instructions.

The at least one processor is configured to execute the program or the instructions, so that the apparatus implements the method in any one of the first aspect or the possible implementations of the first aspect, the apparatus implements the method in any one of the second aspect or the possible implementations of the second aspect, the apparatus implements the method in any one of the third aspect or the possible implementations of the third aspect, the apparatus implements the method in any one of the fourth aspect or the possible implementations of the fourth aspect, the apparatus implements the method in any one of the fifth aspect or the possible implementations of the fifth aspect, or the apparatus implements the method in any one of the sixth aspect or the possible implementations of the sixth aspect.

A fourteenth aspect of embodiments of this application provides a communication apparatus, including at least one logic circuit and an input/output interface.

The logic circuit is configured to perform the method in any one of the first aspect or the possible implementations of the first aspect, the logic circuit is configured to perform the method in any one of the second aspect or the possible implementations of the second aspect, the logic circuit is configured to perform the method in any one of the third aspect or the possible implementations of the third aspect, the logic circuit is configured to perform the method in any one of the fourth aspect or the possible implementations of the fourth aspect, the logic circuit is configured to perform the method in any one of the fifth aspect or the possible implementations of the fifth aspect, or the logic circuit is configured to perform the method in any one of the sixth aspect or the possible implementations of the sixth aspect.

A fifteenth aspect of embodiments of this application provides a computer-readable storage medium that stores one or more computer-executable instructions. When the computer-executable instructions are executed by a processor, the processor performs the method in any one of the first aspect or the possible implementations of the first aspect, the processor performs the method in any one of the second aspect or the possible implementations of the second aspect, the processor performs the method in any one of the third aspect or the possible implementations of the third aspect, the processor performs the method in any one of the fourth aspect or the possible implementations of the fourth aspect, the processor performs the method in any one of the fifth aspect or the possible implementations of the fifth aspect, or the processor performs the method in any one of the sixth aspect or the possible implementations of the sixth aspect.

A sixteenth aspect of embodiments of this application provides a computer program product (or referred to as a computer program) that stores one or more computers. When the computer program product is executed by a processor, the processor performs the method in any one of the first aspect or the possible implementations of the first aspect, the processor performs the method in any one of the second aspect or the possible implementations of the second aspect, the processor performs the method in any one of the third aspect or the possible implementations of the third aspect, the processor performs the method in any one of the fourth aspect or the possible implementations of the fourth aspect, the processor performs the method in any one of the fifth aspect or the possible implementations of the fifth aspect, or the processor performs the method in any one of the sixth aspect or the possible implementations of the sixth aspect.

A seventeenth aspect of embodiments of this application provides a chip system. The chip system includes at least one processor, configured to support a communication apparatus in implementing the function in any one of the first aspect or the possible implementations of the first aspect, configured to support the communication apparatus in implementing the function in any one of the second aspect or the possible implementations of the second aspect, configured to support the communication apparatus in implementing the function in any one of the third aspect or the possible implementations of the third aspect, configured to support the communication apparatus in implementing the function in any one of the fourth aspect or the possible implementations of the fourth aspect, configured to support the communication apparatus in implementing the function in any one of the fifth aspect or the possible implementations of the fifth aspect, or configured to support the communication apparatus in implementing the function in any one of the sixth aspect or the possible implementations of the sixth aspect.

In a possible design, the chip system may further include a memory. The memory is configured to store program instructions and data that are necessary for a first communication apparatus. The chip system may include a chip, or may include a chip and another discrete component. Optionally, the chip system further includes an interface circuit, and the interface circuit provides program instructions and/or data for the at least one processor.

An eighteenth aspect of embodiments of this application provides a communication system. The communication system includes the communication apparatus in the seventh aspect and the communication apparatus in the eighth aspect; the communication system includes the communication apparatus in the ninth aspect and the communication apparatus in the tenth aspect; the communication system includes the communication apparatus in the eleventh aspect and the communication apparatus in the twelfth aspect; the communication system includes the communication apparatus in the thirteenth aspect; and/or the communication system includes the communication apparatus in the fourteenth aspect.

For technical effects brought by any design manner in the seventh aspect to the eighteenth aspect, refer to technical effects brought by different design manners in the first aspect to the sixth aspect. Details are not described herein again.

### BRIEF DESCRIPTION OF DRAWINGS

FIG. 1a is a diagram of a communication scenario according to this application;

FIG. 1b is another diagram of a communication scenario according to this application;

FIG. 2a is another diagram of a communication scenario according to this application;

FIG. 2b is another diagram of a communication scenario according to this application;

FIG. 2c is another diagram of a communication scenario according to this application;

FIG. 2d is another diagram of a communication scenario according to this application;

FIG. 3 is a diagram of TA adjustment according to this application;

FIG. 4 is another diagram of TA adjustment according to this application;

FIG. 5 is a diagram of discontinuous transmission according to this application;

FIG. 6 is another diagram of discontinuous transmission according to this application;

FIG. 7 is a diagram of a communication method according to this application;

FIG. 8 is another diagram of a communication method according to this application;

FIG. 9 is another diagram of a communication method according to this application;

FIG. 10 is another diagram of a communication method according to this application;

FIG. 11 is another diagram of a communication method according to this application;

FIG. 12 is another diagram of a communication method according to this application;

FIG. 13 is a diagram of a communication apparatus according to this application;

FIG. 14 is another diagram of a communication apparatus according to this application;

FIG. 15 is another diagram of a communication apparatus according to this application;

FIG. 16 is another diagram of a communication apparatus according to this application; and

FIG. 17 is another diagram of a communication apparatus according to this application.

### DESCRIPTION OF EMBODIMENTS

The following describes technical solutions in embodiments of this application with reference to the accompanying drawings in embodiments of this application. All other embodiments obtained by a person of ordinary skill in the art based on embodiments of this application without creative efforts shall fall within the protection scope of this application.

First, some terms in embodiments of this application are explained and described, to facilitate understanding of a person skilled in the art.

(1) A terminal device may be a wireless terminal device that can receive scheduling and indication information of a network device. The wireless terminal device may be a device that provides voice and/or data connectivity for a user, a handheld device with a wireless connection function, or another processing device connected to a wireless modem.

The terminal device may communicate with one or more core networks or the internet via a radio access network (radio access network, RAN). The terminal device may be a mobile terminal device, for example, a mobile telephone (or referred to as a “cellular” phone or a mobile phone (mobile phone)), a computer, and a data card. For example, the terminal device may be a portable, pocket-sized, handheld, computer built-in, or vehicle-mounted mobile apparatus that exchanges a voice and/or data with the radio access network. For example, the terminal device may be a device such as a personal communications service (personal communications service, PCS) phone, a cordless phone, a session initiation protocol (SIP) phone, a wireless local loop (wireless local loop, WLL) station, a personal digital assistant (personal digital assistant, PDA), a tablet computer (tablet computer), or a computer with a wireless transceiver function. The wireless terminal device may also be referred to as a system, a subscriber unit (subscriber unit), a subscriber station (subscriber station), a mobile station (mobile station), a mobile station (mobile station, MS), a remote station (remote station), an access point (access point, AP), a remote terminal (remote terminal) device, an access terminal (access terminal) device, a user terminal (user terminal) device, a user agent (user agent), a subscriber station (subscriber station, SS), customer premises equipment (customer premises equipment, CPE), a terminal (terminal), user equipment (user equipment, UE), a mobile terminal (mobile terminal, MT), an uncrewed aerial vehicle, or the like. The terminal device may alternatively be a wearable device and a terminal device in a next generation communication system, for example, a terminal device in a 5G communication system or a terminal device in a future evolved public land mobile network (public land mobile network, PLMN).

(2) The network device may be a device in a wireless network. For example, the network device may be a radio access network (radio access network, RAN) node (or device) that connects the terminal device to the wireless network, or may be referred to as a base station. Currently, some examples of the RAN device are: a next generation NodeB (generation NodeB, gNodeB) in the 5G communication system, a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB or a home NodeB, HNB), a baseband unit (baseband unit, BBU), a wireless fidelity (wireless fidelity, Wi-Fi) access point (access point, AP), or the like. In addition, in a network structure, the network device may include a central unit (central unit, CU) node, a distributed unit (distributed unit, DU) node, or a RAN device including the CU node and the DU node.

In some implementations, the network device may further include a satellite, aircraft, an unmanned aerial vehicle, or the like.

The network device can send configuration information (for example, carried in a scheduling message and/or an indication message) to the terminal device. The terminal device further performs a network configuration based on the configuration information, so that the network configurations of the network device and the terminal device are aligned. Alternatively, a network configuration is preset in the network device and a network configuration is preset in the terminal device, so that the network configurations of the network device and the terminal device are aligned. Specifically, “alignment” means that when there is an interaction message between the network device and the terminal device, the network device and the terminal device have a consistent understanding of a carrier frequency for sending and receiving the interaction message, determining of a type of the interaction message, a meaning of field information carried in the interaction message, or another configuration of the interaction message.

In addition, in another possible case, the network device may be another apparatus that provides a wireless communication function for the terminal device. A specific technology and a specific device form that are used by the network device are not limited in embodiments of this application. For ease of description, this is not limited in embodiments of this application.

The network device may further include a core network device. The core network device includes, for example, an access and mobility management function (access and mobility management function, AMF), a user plane function (user plane function, UPF), or a session management function (session management function, SMF).

In embodiments of this application, an apparatus configured to implement a function of the network device may be the network device, or may be an apparatus, for example, a chip system, that can support the network device in implementing the function. The apparatus may be installed in the network device. In the technical solutions provided in embodiments of this application, an example in which the apparatus configured to implement the function of the network device is the network device is used for describing the technical solutions provided in embodiments of this application.

(3) Configuration and preconfiguration: In this application, both the configuration and the preconfiguration are used. The configuration means that the network device sends configuration information of some parameters or parameter values to the terminal device by using a message or signaling, so that the terminal device determines a communication parameter or a transmission resource based on the values or the information. Similar to the configuration, the preconfiguration may be parameter information or a parameter value negotiated by the network device and the terminal device in advance, may be parameter information or a parameter value that is used by the network device or the terminal device and that is specified in a standard protocol, or may be parameter information or a parameter value that is pre-stored in the network device or the terminal device. This is not limited in this application.

Further, these values and parameters may be changed or updated.

(4) A beam is a communication resource. A technology for forming the beam may be a beamforming technology or another technical means. The beamforming technology may be specifically a digital beamforming technology, an analog beamforming technology, or a hybrid digital/analog beamforming technology. Different beams may be embodied by different resources. Same information or different information may be sent through different beams. Optionally, a plurality of beams having same or similar communication features may be considered as one beam. One beam may include one or more antenna ports, configured to transmit a data channel, a control channel, a sounding signal, and the like. The beam has specific directivity or a specific characteristic in space. For example, a transmit beam may be distribution of signal strength formed in different directions in space after a signal is transmitted through an antenna, and a receive beam may be distribution of signal strength, in different directions in space, of a radio signal received from an antenna. It may be understood that one or more antenna ports forming one beam may also be considered as one antenna port set. The beam may alternatively be embodied as a spatial filter (spatial filter) in a protocol. For example, the transmit beam is a spatial domain transmission filter (spatial domain transmission filter), and the receive beam is a spatial domain transmission filter (spatial domain receiver filter). That the transmit beam is the same as the receive beam may mean that a spatial filter used for sending is the same as a spatial filter used for receiving.

It should be understood that different beams may be distinguished in the protocol based on a bandwidth part (bandwidth part, BWP), a transmission configuration indicator (transmission configuration indicator, TCI), or a synchronization signal block (synchronization signal block, SSB). In other words, the beam may be indicated based on the BWP, the TCI, or the SSB. For example, for the terminal and the network device, switching between beams may be indicated by switching between BWPs, TCIs, or SSBs. Therefore, for the terminal and/or the network device, what is actually performed may be switching between the BWPs, the TCIs, or the SSBs. In addition, the beam in this application may also be replaced with the BWP, the TCI, or the SSB.

(5) Terms “system” and “network” may be used interchangeably in embodiments of this application. “At least one” means one or more, and “a plurality of” means two or more. The term “and/or” describes an association relationship between associated objects, and represents that three relationships may exist. For example, A and/or B may represent the following three cases: Only A exists, both A and B exist, and only B exists, where A and B may be singular or plural. The character “/” generally represents an “or” relationship between the associated objects. “At least one of the following items (pieces)” or a similar expression thereof indicates any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” in embodiments of this application are used to distinguish between a plurality of objects, and are not used to limit a sequence, a time sequence, priorities, or importance of the plurality of objects.

This application may be applied to a long term evolution (long term evolution, LTE) system, a new radio (new radio, NR) system, or a new radio vehicle to everything (NR vehicle to everything, NR V2X) system. This application may be further applied to an LTE and 5G hybrid networking system, a device-to-device (device-to-device, D2D) communication system, a machine to machine (machine to machine, M2M) communication system, an internet of things (Internet of Things, IoT), or an unmanned aerial vehicle communication system. Alternatively, this application may be applied to a communication system that supports a plurality of wireless technologies such as an LTE technology and an NR technology, or a non-terrestrial communication system such as a satellite communication system or a high-altitude communication platform. In addition, optionally, the communication system may also be applicable to a narrow band-internet of things (narrow band-internet of things, NB-IoT) system, an enhanced data rate for GSM evolution (enhanced data rate for GSM evolution, EDGE) system, a wideband code division multiple access (wideband code division multiple access, WCDMA) system, a code division multiple access 2000 (code division multiple access, CDMA 2000) system, a time division-synchronization code division multiple access (time division-synchronization code division multiple access, TD-SCDMA) system, and a future-oriented communication technology. Alternatively, the communication system is another communication system. The communication system includes the network device and the terminal device. The network device is used as a configuration information sending entity, and the terminal device is used as a configuration information receiving entity. Specifically, in the communication system, an entity sends configuration information to another entity, and sends data to the another entity, or receives data sent by the another entity. The another entity receives the configuration information, and sends the data to the configuration information sending entity based on the configuration information, or receives the data sent by the configuration information sending entity. This application may be applied to a terminal device in a connected state or an active (active) state, or may be applied to a terminal device in a non-connected (inactive) state or an idle (idle) state.

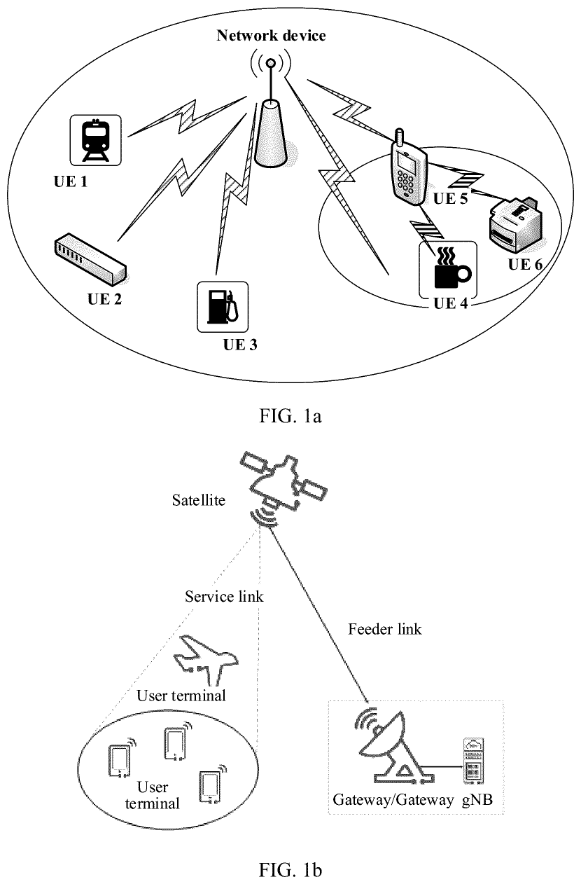

FIG. 1a is a diagram of an application scenario according to an embodiment of this application. As shown in FIG. 1a, a configuration information sending entity may be a network device, and configuration information receiving entities may be UE 1 to UE 6. In this case, a base station and the UE 1 to the UE 6 form a communication system. In the communication system, the UE 1 to the UE 6 may send uplink data to the network device, and the network device needs to receive the uplink data sent by the UE I to the UE 6. In addition, the network device may send configuration information to the UE 1 to the UE 6.

As shown in FIG. 1a, in a communication process, a sending device (or referred to as a transmitting end or a transmitting device) may be a network device, and a receiving device (or referred to as a receiving end or a receiving device) may be a terminal device; a sending device may be a terminal device, and a receiving device may be a network device; both a sending device and a receiving device may be network devices; or both a sending device and a receiving device may be terminal devices.

FIG. 1b is a diagram of another application scenario according to an embodiment of this application. A communication scenario shown in FIG. 1b may be referred to as a satellite communication scenario. In this scenario, a network device includes a satellite device and a gateway (gateway). A terminal device includes an internet of things terminal, or may be a terminal having another form and other performance, for example, a phone mobile terminal or high-altitude aircraft. This is not limited herein. A link between a satellite and the terminal device is referred to as a service link (service link), and a link between the satellite and the gateway is referred to as a feeder link (feeder link). The solutions of this application may also be applied to a multi-satellite communication scenario extended from the communication scenario shown in FIG. 1b.

It should be noted that the technical solutions in embodiments of this application are applicable to a communication system that integrates terrestrial communication and satellite communication. The communication system may also be referred to as a non-terrestrial network (non-terrestrial network, NTN) communication system. A terrestrial communication system may be, for example, a long term evolution (long term evolution, LTE) system, a universal mobile telecommunications system (universal mobile telecommunications system, UMTS), a 5G communication system, a new radio (new radio, NR) system, or a communication system further developed from the 5G communication system. This is not limited herein.

Compared with a conventional mobile communication system, satellite communication has advantages such as a wider coverage area, supporting different transmission links, communication costs independent of a transmission distance, and overcoming natural geographical obstacles such as oceans, deserts, and mountains. To overcome shortcomings of a conventional communication network, satellite communication may be used as an effective supplement to the conventional network.

It is generally considered that, compared with terrestrial communication, non-terrestrial network (non-terrestrial network, NTN) communication has different channel characteristics such as a large transmission delay and a large Doppler shift. For example, a round trip delay of GEO satellite communication is 238 milliseconds (ms) to 270 milliseconds. A round trip delay of LEO satellite communication is 8 ms to 20 ms. Satellite communication systems may be classified into the following three types based on different orbital heights: a geostationary earth orbit (geostationary earth orbit, GEO) satellite communication system, which is also referred to as a synchronous orbit satellite system; a medium earth orbit (medium earth orbit, MEO) satellite communication system; and a low earth orbit (low earth orbit, LEO) satellite communication system.

Generally, a GEO satellite is also referred to as a geostationary orbit satellite, and an orbital height may be 35,786 kilometers (km). A main advantage of the GEO satellite is that the satellite is stationary relative to the ground and provides a large coverage area. However, the GEO satellite has the following disadvantages: If the satellite is at an extremely long distance from the earth, a large-diameter antenna is required. A transmission delay of the GEO satellite is large, is about 0.5 seconds, and cannot meet a requirement of a real-time service. In addition, the GEO satellite has restrained orbit resources and high transmission costs, and cannot provide coverage for the polar areas. An MEO satellite has an orbital height of 2,000 km to 35,786 km, and a small quantity of satellites can implement global coverage. However, the MEO satellite has a larger transmission delay than an LEO satellite, and is mainly used for positioning and navigation. In addition, a satellite whose orbital height is 300 km to 2,000 km is referred to as a low earth orbit (LEO) satellite. Compared with the MEO satellite and the GEO satellite, the LEO satellite has a lower orbital height, a smaller data transmission delay, a lower power loss, and lower transmission costs. Therefore, an LEO satellite communication network has made great progress in recent years and has attracted attention.

In a possible implementation, working modes of the satellite device may be classified into a transparent (transparent) transmission mode and a regeneration (regeneration) mode.

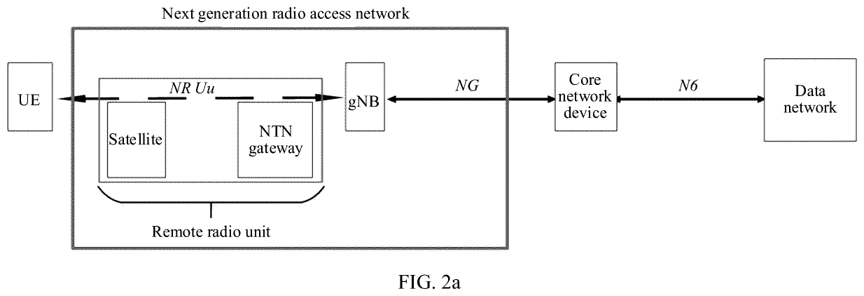

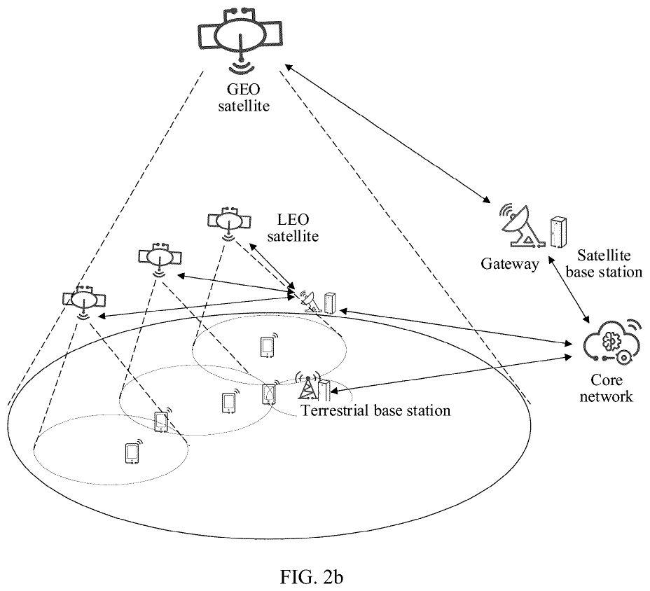

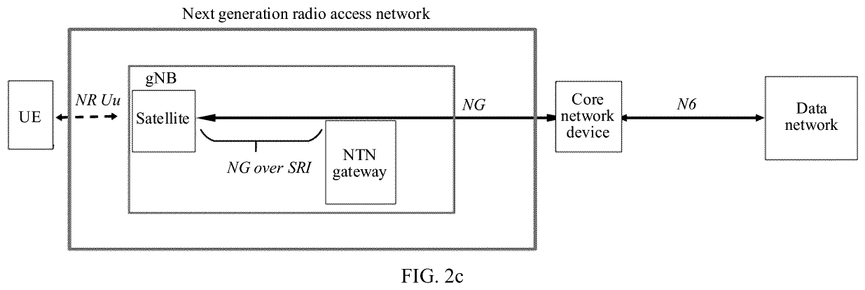

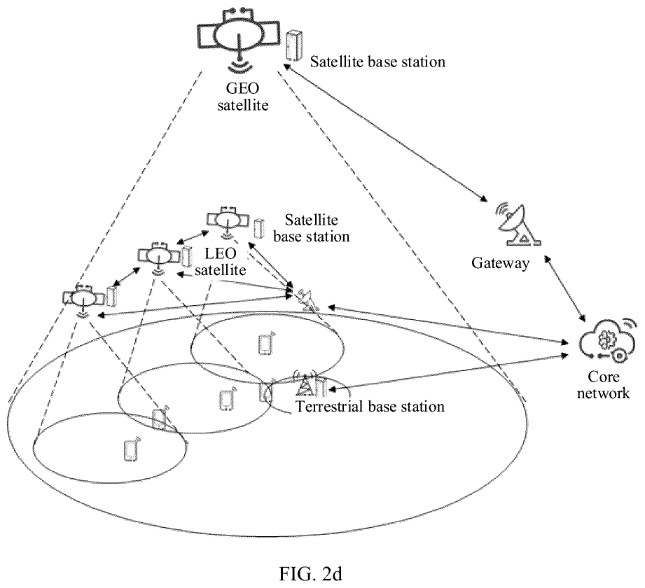

The following provides example descriptions of the two modes by using implementations shown in FIG. 2a to FIG. 2d. In the following examples, a terminal device is UE and an access network device in a network device includes a gNB.

In the implementation of the transparent transmission mode shown in FIG. 2a, a satellite and an NTN gateway are used as a relay, namely, a remote radio unit (Remote Radio Unit) shown in FIG. 2a. Communication between the UE and the gNB needs to be implemented by using a relay process. In other words, in the transparent transmission mode, the satellite has a relay forwarding function. In addition, the remote radio unit and the gNB in FIG. 2a may be used as a next generation radio access network (NG-RAN), so that the UE communicates with a core network device (5G CN), a data network (Data Network), and the like.

For example, in the implementation of the transparent transmission mode shown in FIG. 2b, when a satellite (including a GEO satellite or an LEO satellite) works in the transparent transmission mode, the satellite has a relay forwarding function. A gateway has functions of a base station or some functions of the base station, and in this case, the gateway may be considered as the base station. Alternatively, a base station and a gateway may be separately deployed. In this case, a delay of a feeder link includes two parts: a delay from the satellite to the gateway and a delay from the gateway to the gNB.

Optionally, a case in which the gateway and the gNB are located together or close to each other may be used as an example for the transparent transmission mode. When the gateway is far away from the gNB, the delay of the feeder link is a sum of the delay from the satellite to the gateway and the delay from the gateway to the gNB.

In the implementation of the regeneration mode shown in FIG. 2c, a satellite and an NTN gateway are used as a gNB, and may communicate with the UE. In other words, in the regeneration mode, the satellite has functions of a base station or some functions of the base station, and in this case, the satellite may be considered as the base station. In addition, the gNB in FIG. 2c may be used as a next generation radio access network (NG-RAN), so that the UE communicates with a core network device (5G CN), a data network (Data Network), and the like.

For example, when a satellite (including a GEO satellite or an LEO satellite) works in the regeneration mode, compared with the implementation shown in FIG. 2b in which the satellite has the functions of the base station or some functions of the base station, and in this case, the satellite may be considered as the base station, the implementation of the regeneration mode shown in FIG. 2d has a disadvantage of high costs.

It should be noted that an NTN and a base station of a terrestrial network may be interconnected via a common core network. Alternatively, assistance and interconnection with higher time validity may be implemented through an interface defined between base stations. In NR, the interface between the base stations is referred to as an Xn interface, and an interface between the base station and the core network is referred to as an NG interface. In a converged network, both an NTN node and a terrestrial node may implement interworking and collaboration through the foregoing interfaces.

The foregoing content describes a plurality of scenarios of wireless communication in this application. It should be understood that the foregoing content is merely example descriptions of a scenario to which this application can be applied. This application may be further applied to another application scenario. This is not limited herein.

In a wireless communication process, because of existence of a transmission delay, to ensure orthogonal transmission of uplink signals of a plurality of terminal devices, the terminal devices need to send the uplink signals based on different timing advance (timing advance, TA) information. This process is referred to as uplink timing advancing. Generally, the terminal device may update a TA based on an indication of a network device. This manner may also be referred to as a closed-loop TA adjustment manner.

For example, in the closed-loop TA adjustment manner, the network device configures the terminal device to send an SRS, to implement closed-loop TA adjustment. First, the network device configures the terminal device to periodically or a periodically send the SRS. After the terminal device sends the SRS based on the configuration of the network device, the network device detects an uplink TA value based on the SRS signal, and then notifies the terminal device of an updated TA value by using a timing advance command (TA command, TAC).

Currently, in a satellite communication scenario, a satellite is used as a network device. Because the satellite moves at a high speed, the TA may change rapidly, and the closed-loop adjustment manner easily causes large overheads. For example, because an LEO satellite moves at a high speed, the TA of the terminal device changes rapidly. In this case, a conventional closed-loop TA adjustment mechanism is excessively frequently used in an LEO satellite scenario, resulting in huge signaling overheads. Currently, a manner of combining open-loop and closed-loop TA adjustment is proposed to reduce necessary closed-loop TA adjustment.

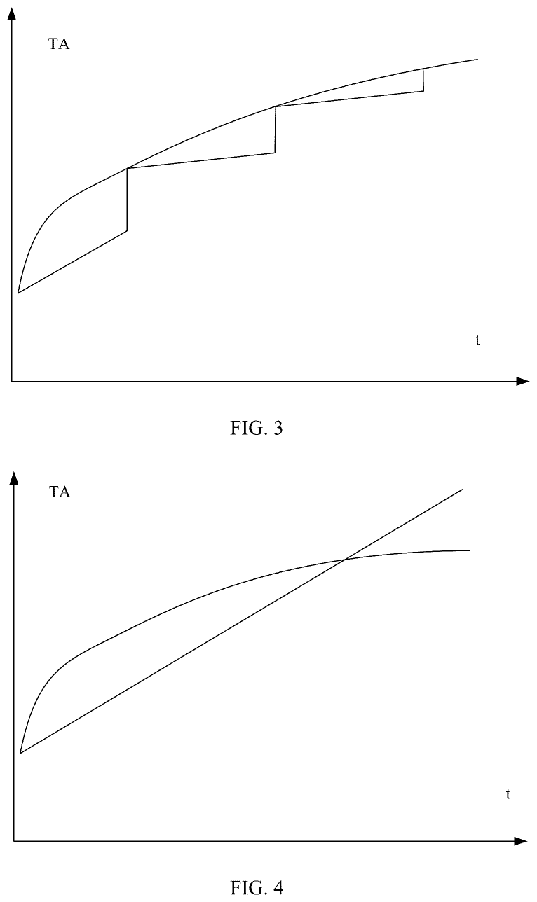

An implementation shown in FIG. 3 is used as an example. The implementation may be open-loop and closed-loop TA adjustment in a connected state. In FIG. 3, a horizontal coordinate represents time, and a vertical coordinate represents a TA value. In addition, in FIG. 3, a curve is an ideal TA, and straight line segments form an actual TA. The “actual TA” in FIG. 3 includes three short line segments parallel to the vertical coordinate, and the three short line segments represent closed-loop TA adjustment. The “actual TA” in FIG. 3 further includes other three long line segments not parallel to the vertical coordinate, and the three long line segments represent open-loop TA adjustment. Therefore, a manner in which the terminal device performs TA adjustment based on a historical change rate of the TA at an interval between two times of closed-loop TA adjustment may be referred to as an open-loop adjustment manner. In this way, the interval between the two times of closed-loop TA adjustment can be appropriately prolonged.

To further prolong the interval between the two times of closed-loop TA adjustment, the terminal device may perform high-order fitting according to a change rule of the TA. For example, FIG. 3 may be referred to as a first-order terminal device open-loop TA modulation mechanism based on a TA change rate (TA rate). When the implementation cannot meet a requirement, a manner shown in FIG. 4 may be used for implementation. In FIG. 4, a curve represents an ideal TA, and a straight line represents an actual TA. In the implementation shown in FIG. 4, a second-order open-loop TA adjustment mechanism based on a change rate (TA rate rate) of the TA change rate may theoretically prolong effective time of TA self-compensation of the terminal device, but generate a TA error for a result due to a limitation of processing precision of the terminal device. The processing precision of the terminal device is affected by at least quantization precision and polynomial fitting precision. In other words, a higher-order compensation mechanism is further limited by the processing precision of the terminal device. When a next time of beam hopping for coverage arrives, a residual TA error may exceed a residual time offset that can be received on an orthogonal frequency division multiplexing (orthogonal frequency division multiplexing, OFDM) symbol. In particular, this problem is more serious in a scenario in which there are a large quantity of high-frequency NTN beams and a short cyclic prefix (cyclic prefix, CP).

In addition, a future satellite system uses a high-gain beam to obtain a sufficient link budget. However, a coverage area of the high-gain beam is small, and consequently, a quantity of beams that need to be scanned in a coverage area of a single satellite is huge (for example, an order of magnitude from 10\hat{ }4 to 10\hat{ }5). Because a quantity of beams that can be simultaneously emitted by one satellite is limited (for example, less than 10), a quantity of beams that need to be scanned for each beam is an order of magnitude from 10\hat{ }3 to 10\hat{ }4. It is estimated, based on average residence time 1 ms of one beam, that it takes 1 s to 10 s to scan a circle of beams of each satellite. In other words, if a terminal device is located in an area covered by a communication beam of a satellite, the terminal device has a transmission opportunity to communicate with the satellite, and may perform uplink/downlink data transmission. Because there are a large quantity of beams that need to be scanned in a signal coverage area of the satellite, and a quantity of beams that can be used by the satellite for communication at a moment is limited, beams used for communication between the satellite and a terminal device in the signal coverage area of the satellite are discontinuous, in other words, transmission opportunities of the terminal device are discontinuous.

It should be understood that, in the foregoing scenario, that the transmission opportunities of the terminal device are discontinuous may also be expressed as that a beam used for communication between the terminal device and the network device is a hopping beam (hopping beam).

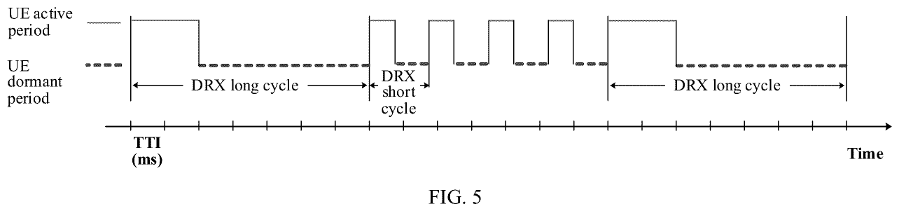

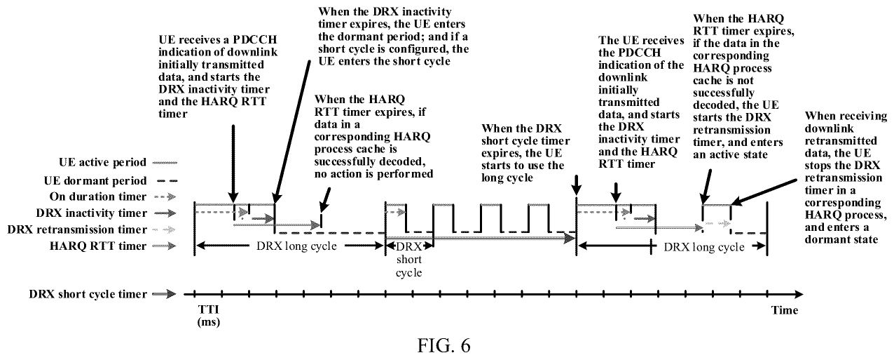

In a current communication system, there are also similar discontinuous communication technologies, including a discontinuous reception (discontinuous reception, DRX) technology and a discontinuous transmission (discontinuous transmission, DRT) technology. The DRX technology is used to reduce a power loss of the terminal device, to achieve energy saving effect. Beam hopping is used to complete full coverage in a case of limited satellite resources. For example, the terminal device monitors a downlink physical downlink control channel (physical downlink control channel, PDCCH) signal in an active period defined in the DRX technology, and does not monitor the PDCCH signal in a dominant period. In a scenario in which a service volume is small or there is only a discrete burst service, a DRX mode can save power for the UE. The following further describes an implementation process of DRX with reference to implementation processes in FIG. 5 and FIG. 6 by using an example in which the terminal device is the UE.

As shown in FIG. 5, the DRX technology includes the following process.

UE active period: The UE needs to continuously monitor a PDCCH, where an on duration (On duration Timer) parameter is used, and the parameter includes time indicated by “DRX activity time (DRX Inactivity Timer)” and time indicated by “DRX retransmission time (DRX Retransmission Timer)”.

UE dominant period: The UE does not need to monitor the PDCCH.

A DRX cycle includes a long cycle (LongCycle) and a short cycle (ShortCycle).

Optionally, parameters configured by a network side for the UE are used to define a quantity of subframes that the DRX cycle lasts, and include the following.

LongCycle indicates a length of the long cycle, where the length may be configured to 10 ms to 10,240 ms, and a default length is 320 ms.

ShortCycle indicates a length of the short cycle, where the length may be configured to 2 ms to 640 ms, and a default length is 80 ms.

LongCycle is K times of ShortCycle, and K≥2.

Quantity of repetition times of the length of the DRX short cycle, namely, ShortCycleTimer: A value may be configured to 0 to 16, the value 0 indicates that a ShortCycle configuration does not take effect, and a default value is 0.

The UE uses the long cycle by default. If the short cycle is configured for the UE, the UE switches to the short cycle when the DRX inactivity timer expires or the UE receives a DRX MAC command, to achieve a better service delay effect. In addition, when the timer short cycle timer (quantity of continuous repetition times of the short cycle) expires, the UE switches back to the long cycle, to save power for the UE.

As shown in FIG. 6, parameters used in a DRX procedure include the following.

On duration timer: The timer indicates a quantity of consecutive downlink subframes. During running of the timer, the UE needs to continuously monitor the PDCCH.

Optionally, the timer needs to be started at the beginning of an active period of each new cycle.

Optionally, when the timer expires, the UE enters the dominant period (where it is noted that if the DRX inactivity timer is running, the UE stays in the active period).

DRX inactivity timer: The timer is used to determine whether the active period of the UE is extended due to arrival of new data, and also provides a time reference for the UE to use the DRX short cycle.

Optionally, during running of the timer, the UE needs to continuously monitor the PDCCH.

Optionally, the timer is started or restarted when a PDCCH indication of initially transmitted data is received.

Optionally, when the timer expires, if the UE is in the long cycle, and the short cycle is configured, the UE starts to use the short cycle, and starts the short cycle timer; or if the UE is in the short cycle, the UE starts the short cycle timer.

Optionally, if the active period exceeds the DRX cycle due to several repeated inactivity, next alignment is required.

It should be understood that, DRX is different from beam hopping, and beam hopping cannot prolong the active period at any time.

DRX short cycle timer: The timer indicates the quantity of repetition times of the length of the DRX short cycle, where the value may be configured to 0 to 16, the value 0 indicates that the ShortCycle configuration does not take effect, and the default value is 0.

Optionally, when the timer expires, the UE enters the long cycle.

When the DRX inactivity timer expires or the UE receives the DRX MAC command, the UE switches to the short cycle, and starts or restarts the timer.

DRX command MAC control element: The command stops the DRX inactivity timer and enables the UE to enter the dominant period in advance.

Optionally, after the command is delivered, if short cycle DRX is configured for the UE, the UE needs to enter short cycle DRX. Therefore, the UE can enter a short cycle DRX state when an exception occurs.

HARQ RTT timer: The timer indicates a predicted minimum time interval for retransmission arrival. Before the timer expires, behavior of the terminal device is not limited. After the timer expires, the UE is woken up and starts the DRX retransmission timer.

Start time of the timer is as follows: (1) Downlink initially transmitted data occurs. (2) Downlink retransmitted data occurs. (3) Downlink data is preconfigured, and this mainly refers to downlink data transmission configured in a semi-static manner, for example, data transmission during VOIP.

When the HARQ RTT timer triggered by data retransmission expires, the UE is not woken up, and the DRX retransmission timer is not started.

It should be understood that, this is different from beam hopping, beam hopping cannot enable the active period at any time.

DRX retransmission timer: The timer indicates predicted maximum waiting time that the UE waits for retransmission in the active period, and the UE needs to continuously monitor the PDCCH.

Optionally, when the HARQ RTT timer expires, if corresponding downlink data is not successfully demodulated, the timer is started.

Optionally, the timer is disabled when retransmitted data is received.

It should be noted that, a default carrier or an initial bandwidth part (initial bandwidth part, initial BWP) is defined in the DRX technology. Although the hopping beam of the satellite is also characterized by discontinuous transmission and reception, a hopping dimension not only includes a time change, but also includes a frequency change and a polarization dimension change. The network device may notify the terminal device of information about a pattern covered by beam hopping each time, where the information includes start time and end time of beam hopping, a frequency domain resource in which beam hopping is performed, polarization information, and the like. Based on the information, the terminal device may know that uplink information should be received and sent in specified time based on the frequency domain resource and the polarization information, to perform closed-loop TA adjustment. Due to a large round trip delay of the satellite, there may be an offset between time of uplink and downlink beam hopping.

In conclusion, due to a limitation of processing precision of the terminal device, a long-time open-loop adjustment manner causes TA error accumulation. When transmission opportunities of the terminal device are discontinuous (that is, beam hopping exists), because resource information (for example, frequency domain resources and polarization information) between different transmission opportunities may not be completely the same, TA error accumulation is more serious, and intersymbol interference of an uplink signal is easily caused.

To resolve the foregoing problem, this application provides a communication method and a communication apparatus. The following provides descriptions with reference to more accompanying drawings.

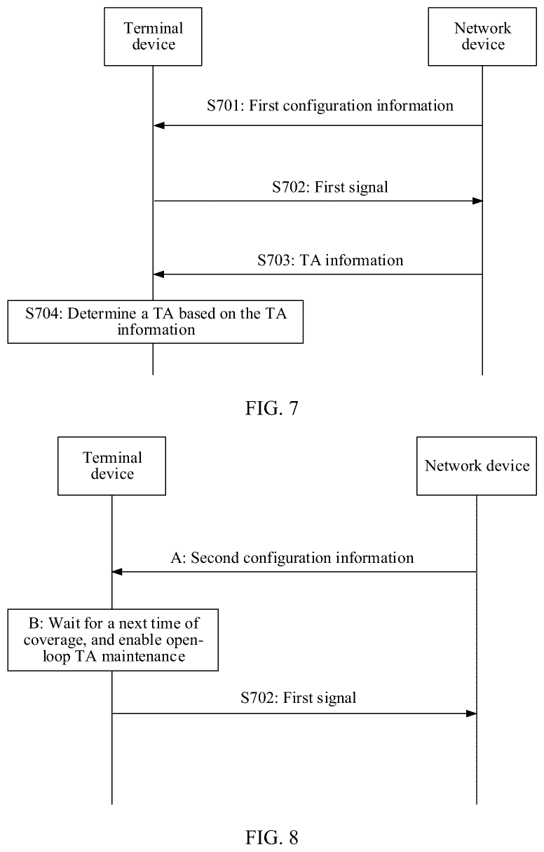

FIG. 7 is a diagram of a communication method according to this application. The method includes the following steps.
S701: A network device sends first configuration information.

In this embodiment, the network device sends the first configuration information in step S701, and correspondingly, a terminal device receives the first configuration information in step S701. The first configuration information includes time domain information of a first transmission opportunity.

In a possible implementation, the first configuration information further includes at least one of frequency domain information of the first transmission opportunity and polarization information of the first transmission opportunity. Specifically, the first configuration information may further include at least one of the frequency domain information of the first transmission opportunity and the polarization information of the first transmission opportunity, so that the terminal device further determines, based on the first configuration information, resource information corresponding to the first transmission opportunity.

It should be understood that, a “transmission opportunity (for example, the first transmission opportunity or a second transmission opportunity)” in this application may be replaced with a “hopping beam (for example, a first hopping beam or a second hopping beam)”. For example, in a system based on beam communication, a terminal device in an area covered by a communication beam of a network device may communicate with the network device. In other words, if a terminal device is located in the area covered by the communication beam of the network device, the terminal device has a transmission opportunity to communicate with the network device, and may perform uplink and/or downlink data transmission. In a scenario in which a satellite is used as a network device, because a quantity of beams that need to be scanned in a signal coverage area of the network device is large, and a quantity of beams that can be used by the network device for communication at a moment is limited, beams used for communication between the network device and a terminal device in the signal coverage area of the network device are discontinuous. In other words, transmission opportunities of the terminal device may be discontinuous in time domain, or the transmission opportunity of the terminal device hops in time domain, that is, the beam used for communication between the terminal device and the network device hops, and may be referred to as a hopping beam (hopping beam).
S702: The terminal device sends a first signal.

In this embodiment, the terminal device sends the first signal in step S702, and correspondingly, the network device receives the first signal in step S702. The first signal is used to determine TA information.

In a possible implementation, the first signal includes an SRS or a preamble (preamble).

In a possible implementation, frequency domain information that carries the first signal is the same as the frequency domain information of the first transmission opportunity; and/or polarization information corresponding to the first signal is the same as the polarization information corresponding to the first transmission opportunity.

Specifically, resource information (including frequency domain information and/or polarization information) corresponding to different transmission opportunities may be different. Therefore, when resource information corresponding to the first signal sent before a time domain start location corresponding to the time domain information of the first transmission opportunity is the same as that corresponding to the first transmission opportunity, a probability that the first signal is received by the network device can be increased.

Optionally, the frequency domain information that carries the first signal is different from the frequency domain information of the first transmission opportunity; and/or the polarization information corresponding to the first signal is different from the polarization information corresponding to the first transmission opportunity.

In a possible implementation, before the terminal device sends the first signal in step S702, the method further includes: The terminal device receives second configuration information from the network device, where the second configuration information includes time domain information that carries the first signal.

Optionally, the second configuration information further includes at least one of a generation parameter of the first signal, the frequency domain information that carries the first signal, and the polarization information corresponding to the first signal.

Specifically, before the terminal device sends the first signal in step S702, the terminal device may further receive, from the network device, the second configuration information that includes the time domain information that carries the first signal, so that the terminal device determines the time domain information corresponding to the first signal, and another configuration that is related to the first signal and that may be further included in the second configuration information.

For example, a relationship between a sending and receiving process of the second configuration information and step S702 may be embodied in an implementation shown in FIG. 8. As shown in FIG. 8, before step S702, the network device sends the second configuration information to the terminal device in step A, where the second configuration information includes at least the time domain information that carries the first signal. Then, before a time domain start location corresponding to the time domain information that carries the first signal, the terminal device performs step B, to be specific, the terminal device waits for coverage of a next transmission opportunity, and enables open-loop TA maintenance. After the time domain start location corresponding to the time domain information that carries the first signal, the terminal device performs step S702, to be specific, the terminal device sends the first signal, to perform closed-loop TA adjustment.

Optionally, the time domain information that carries the first signal includes a first parameter, and the first parameter is associated with a time interval between different transmission opportunities. Specifically, the time domain information that carries the first signal includes the first parameter, and the first parameter is associated with the time interval between the different transmission opportunities, so that the terminal device sends the first signal based on the first parameter at (or before) a time domain start location corresponding to the next transmission opportunity, and the terminal device receives, from the network device at (or after) the time domain start location corresponding to the next transmission opportunity, the TA information determined based on the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

In an implementation example, before step S702, the terminal device needs to determine, in the following manner, a time domain location that carries the first signal:

$$⌊ n \cdot {2}^{\frac{{μ}_{SRS}}{{μ}_{PDCCH}}} ⌋ + k + {k}_{offset} + {k}_{BH} .$$

n is a sequence number of a slot (slot) triggered when the terminal device receives the first signal.
k is the second parameter, and is a scheduling time offset of the first signal configured by the upper layer.
k_{offest} is the third parameter, and is an additional offset introduced in a 3GPP R16/R17 NTN scenario, and a corresponding time length needs to be greater than a round trip delay in the NTN scenario.
k_{BH} is the first parameter, and is an offset that is introduced in this embodiment and that is related to a time interval between beam hopping.

Therefore, an uplink scheduling offset of the first signal is further extended, and an additional extension amount is related to a time interval between two times of beam hopping for coverage, so that the scheduled first signal can arrive at the network device slightly earlier than a next time of beam hopping for downlink coverage. Based on the first parameter in the foregoing implementation, the first signal is scheduled within time of current beam hopping for coverage, and time at which the terminal device actually sends the first signal in step S702 is slightly earlier than the next time of beam hopping for downlink coverage.

In a possible implementation, before the terminal device receives the second configuration information from the network device, the method further includes: The terminal device sends first capability information to the network device, where the first capability information indicates a TA time synchronization capability of the terminal device.

Specifically, the terminal device may further send the first capability information indicating the TA time synchronization capability of the terminal device, so that the network device can determine, based on the first capability information, whether the terminal device needs to enable closed-loop TA adjustment related to a transmission opportunity, and when the network device determines that closed-loop TA adjustment related to the transmission opportunity needs to be enabled, the network device sends, to the terminal device, the second configuration information corresponding to the first signal.

For example, after receiving the first capability information from the terminal device, the network device may configure different closed-loop TA adjustment policies for the terminal device based on different TA time synchronization capabilities indicated by the first capability information. The TA time synchronization capability of the terminal device is agreed on between the terminal device and the network device in a preconfiguration manner or a configuration manner. Examples are as follows.

In a TA tracking capability level 1, the terminal device may perform open-loop compensation at a TA rate level, and in this case, the network device may configure a TA closed-loop operation for a scenario in which the beam hopping interval is greater than a specific threshold;
in a TA tracking capability level 2, the terminal device may perform open-loop compensation at a TA rate rate level, and in this case, the network device configures a TA closed-loop operation for a scenario in which the beam hopping interval is greater than another specific threshold;
. . . ; and
in a TA tracking capability level N, the terminal device has a good information calibration capability, to be specific, the network device determines that an error corresponding to open-loop TA adjustment performed by the terminal device is less than a threshold. For example, the terminal device has a perfect global navigation satellite system (global navigation satellite system, GNSS) information calibration capability, and may perform perfect open-loop TA adjustment. In this case, the network device does not need to configure a TA closed-loop operation.

Therefore, the terminal device notifies the network device of the capability when accessing or after accessing the network device, and the network device can configure different closed-loop TA adjustment policies for different terminal devices based on capability information of the terminal devices.

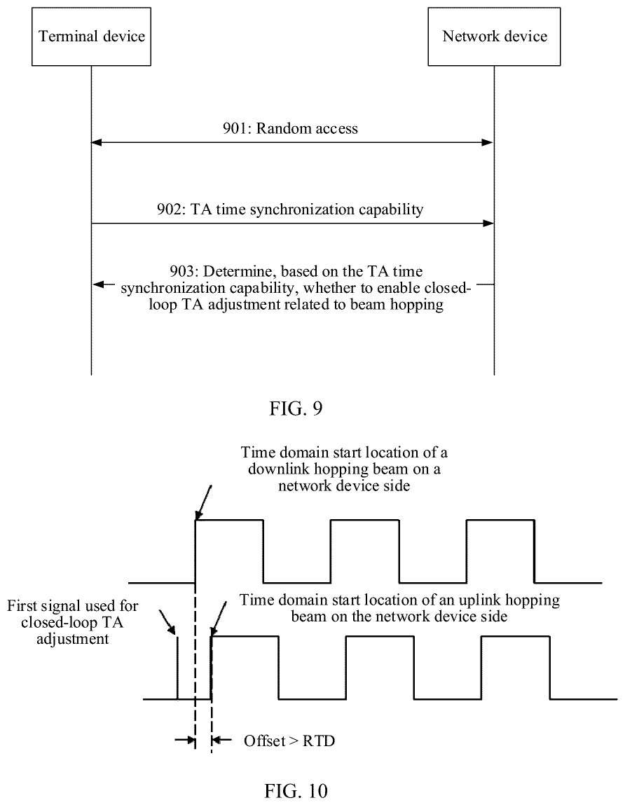

For example, a typical reporting procedure diagram is shown in FIG. 9. As shown in FIG. 9, an implementation process in which the terminal device notifies the network device of the first capability information after accessing the network device is used as an example. After random access is completed in step S901, the terminal device sends, to the network device in step S902, the first capability information indicating the TA time synchronization capability, so that the network device determines, in step S903 based on the TA time synchronization capability indicated by the first capability information, whether to enable closed-loop TA adjustment related to beam hopping. If the network device determines to enable closed-loop TA adjustment related to beam hopping, the network device sends a related resource configuration (for example, the second configuration information) of the first signal to the terminal device in step S903, so that the terminal device sends the first signal based on the resource configuration, to perform closed-loop TA adjustment.

Optionally, a TA tracking capability of a specific terminal device may be transferred between network devices. When the terminal device is handed over (for example, performs cell handover or cell reselection) between the network devices, a target network device after the handover can also obtain corresponding capability information.

In a possible implementation, before the terminal device sends the first signal to the network device, the method further includes: The terminal device receives first indication information from the network device, where the first indication information indicates a first time period; and when the terminal device determines that a current moment falls within the first time period, the terminal device sends the first signal to the network device.

Specifically, when the terminal device determines that the current moment falls within the first time period indicated by the network device by using the first indication information, the terminal device determines that closed-loop TA adjustment needs to be performed based on an indication of the network device. In other words, the terminal device sends the first signal to the network device, to obtain the TA information used to determine a TA between the terminal device and the network device. In other words, the terminal device sends the first signal based on an indication of the first indication information before beam hopping transmission in a specific time range starts. Optionally, in the specific time range, a change amount of a TA rate (or a TA rate rate) of the terminal device is large.

Optionally, when the terminal device determines that the current moment does not fall within the first time period, the terminal device does not need to send the first signal to the network device.

Optionally, the first indication information includes at least one of a start moment of the first time period, an end moment of the first time period, and duration of the first time period. For example, the first indication information may specifically include at least one of the following implementations.
(1) If absolute time is used to represent the first time period, universal time coordinated (universal time coordinated, UTC) may be used to represent the start moment of the first time period or the end moment of the first time period. Optionally, the duration of the first time period may be further indicated as how many milliseconds, seconds, or the like.
(2) If relative time is used to represent the first time period, a system frame number (system frame number, SFN) may be used to represent the start moment of the first time period or the end moment of the first time period. Optionally, the duration of the first time period may be further indicated as a quantity of frames, subframes, or the like.
(3) If a time sequence number of a hopping beam pattern is used to represent the first time period, a sequence number (or an index number) of a hopping beam may be used to represent the start moment of the first time period or the end moment of the first time period. Optionally, the duration of the first time period may be further indicated as span of hopping beams in time domain.

In a possible implementation, that the terminal device sends the first signal to the network device includes: The terminal device sends the first signal to the network device before an offset (offset) before the time domain start location.

Specifically, to ensure that the terminal device performs, after a time domain start location corresponding to time domain information of a transmission opportunity, data transmission with the network device based on the TA determined based on the TA information, the terminal device needs to send, in advance, the first signal used to determine the TA information. In other words, the terminal device needs to send the first signal before the offset before the time domain start location.

In a possible implementation, the method further includes: The terminal device receives second indication information from the network device, where the second indication information indicates the offset.

Specifically, before the terminal device sends the first signal, the terminal device further receives the second indication information indicating the offset, so that the terminal device determines, based on the offset, a time domain location for sending the first signal.

Optionally, the offset is preconfigured in the terminal device.
S703: The network device sends the TA information.

In this embodiment, the network device sends the TA information in step S703, and correspondingly, the terminal device receives the TA information in step S703.

In a possible implementation, that the network device sends the TA information to the terminal device includes: The network device determines a difference between a time domain location corresponding to the time domain information of the first transmission opportunity and a time domain location corresponding to time domain information of the second transmission opportunity, where the second transmission opportunity is a transmission opportunity at an adjacent time domain location of the first transmission opportunity; and when the network device determines that the difference is greater than a threshold, the network device sends the TA information.

Specifically, after the network device determines that the difference between the time domain location corresponding to the time domain information of the first transmission opportunity and the time domain location corresponding to the time domain information of the second transmission opportunity is greater than the threshold, the network device determines that a time interval between the first transmission opportunity and an adjacent transmission opportunity is long. If closed-loop TA adjustment is not performed, TA error accumulation may be serious. Therefore, the network device may send the TA information, so that the terminal device can determine the TA between the terminal device and the network device based on the TA information, that is, the terminal device performs closed-loop TA adjustment. In other words, for two times of beam hopping for coverage with a short coverage interval, open-loop TA adjustment of the terminal device may still maintain high precision, and no additional closed-loop TA adjustment may be introduced.

Optionally, when the network device determines that the difference is equal to the threshold, the network device sends the TA information.

Optionally, when the network device determines that the difference is less than or equal to the threshold, the network device does not need to send the TA information.

Optionally, the difference between the time domain location corresponding to the time domain information of the first transmission opportunity and the time domain location corresponding to the time domain information of the second transmission opportunity includes any one of the following: a difference between a start moment of the time domain location corresponding to the time domain information of the first transmission opportunity and a start moment of the time domain location corresponding to the time domain information of the second transmission opportunity; a difference between an end moment of the time domain location corresponding to the time domain information of the first transmission opportunity and an end moment of the time domain location corresponding to the time domain information of the second transmission opportunity; a difference between an end moment of the time domain location corresponding to the time domain information of the first transmission opportunity and a start moment of the time domain location corresponding to the time domain information of the second transmission opportunity; or a difference between a start moment of the time domain location corresponding to the time domain information of the first transmission opportunity and an end moment of the time domain location corresponding to the time domain information of the second transmission opportunity.

Optionally, the threshold is preconfigured in the terminal device, or the terminal device determines the threshold based on an indication of the network device. To be specific, the network device may configure or agree on a threshold related to the coverage interval with the terminal device, to determine whether closed-loop TA adjustment needs to be triggered before one time of beam hopping for coverage. If a coverage interval between two times of beam hopping is greater than the threshold, closed-loop TA adjustment needs to be triggered. Otherwise, closed-loop TA adjustment does not need to be triggered.

Optionally, the difference between the time domain location corresponding to the time domain information of the first transmission opportunity and the time domain location corresponding to the time domain information of the second transmission opportunity includes any one of the following: the difference between the start moment of the time domain location corresponding to the time domain information of the first transmission opportunity and the start moment of the time domain location corresponding to the time domain information of the second transmission opportunity; the difference between the end moment of the time domain location corresponding to the time domain information of the first transmission opportunity and the end moment of the time domain location corresponding to the time domain information of the second transmission opportunity; the difference between the end moment of the time domain location corresponding to the time domain information of the first transmission opportunity and the start moment of the time domain location corresponding to the time domain information of the second transmission opportunity; or the difference between the start moment of the time domain location corresponding to the time domain information of the first transmission opportunity and the end moment of the time domain location corresponding to the time domain information of the second transmission opportunity.
S704: The terminal device determines the TA based on the TA information.

In this embodiment, after the terminal device receives the TA information in step S703, the terminal device determines the TA between the terminal device and the network device based on the TA information in step S704, where the TA is used for data transmission after the time domain start location corresponding to the time domain information of the first transmission opportunity.

In a possible implementation, that the terminal device determines the TA between the terminal device and the network device based on the TA information includes: After the terminal device determines that the difference between the time domain location corresponding to the time domain information of the first transmission opportunity and the time domain location corresponding to the time domain information of the second transmission opportunity is greater than the threshold, the terminal device determines the TA between the terminal device and the network device based on the TA information, where the second transmission opportunity is the transmission opportunity at the adjacent time domain location of the first transmission opportunity.

It should be understood that, in time domain, the time domain location corresponding to the second transmission opportunity is before the time domain location corresponding to the first transmission opportunity; or the time domain location corresponding to the second transmission opportunity is after the time domain location corresponding to the first transmission opportunity.

Specifically, after the terminal device determines that the difference between the time domain location corresponding to the time domain information of the first transmission opportunity and the time domain location corresponding to the time domain information of the second transmission opportunity is greater than the threshold, the terminal device determines that a time interval between the first transmission opportunity and an adjacent transmission opportunity is long. If closed-loop TA adjustment is not performed, TA error accumulation may be serious. Therefore, the terminal device may determine the TA between the terminal device and the network device based on the TA information, that is, the terminal device performs closed-loop TA adjustment.

Optionally, after the terminal device determines that the difference between the time domain location corresponding to the time domain information of the first transmission opportunity and the time domain location corresponding to the time domain information of the second transmission opportunity is equal to the threshold, the terminal device determines the TA between the terminal device and the network device based on the TA information.

Optionally, after the terminal device determines that the difference between the time domain location corresponding to the time domain information of the first transmission opportunity and the time domain location corresponding to the time domain information of the second transmission opportunity is less than or equal to the threshold, the terminal device does not need to determine the TA between the terminal device and the network device based on the TA information.

Based on the foregoing technical solution, the terminal device sends, before the time domain start location corresponding to the time domain information of the first transmission opportunity, the first signal used to determine the TA information. In addition, after the terminal device receives the TA information, the terminal device determines the TA between the terminal device and the network device based on the TA information, where the TA is used for data transmission after the time domain start location corresponding to the time domain information of the first transmission opportunity. In other words, after the time domain start location corresponding to the time domain information of the first transmission opportunity, the terminal device communicates with the network device based on the TA determined based on the TA information. Therefore, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

For example, an implementation shown in FIG. 10 is used as an example. The first signal sent by the terminal device in step S702 is located before a time domain start location of a downlink hopping beam, so that closed-loop TA adjustment corresponding to the first signal is completed before the time domain start location. Then, after the time domain start location, both a downlink signal corresponding to a downlink hopping beam on a network device side and an uplink signal corresponding to the downlink hopping beam on the network device side may use a TA updated through closed-loop TA adjustment, to reduce TA error accumulation caused by the open-loop adjustment manner, reduce intersymbol interference of the uplink signal, and improve stability of the communication system.

Optionally, in FIG. 10, it indicates that an actual start moment of the uplink hopping beam may be later than a start moment of the downlink hopping beam, a difference between the two moments is an “offset”, and a value of the “offset” may be greater than a round trip delay (round trip delay, RTD), that is, “offset>RTD”. It should be understood that there may be another mathematical relationship between the “offset” and the “RTD”. This is merely an example for description herein.

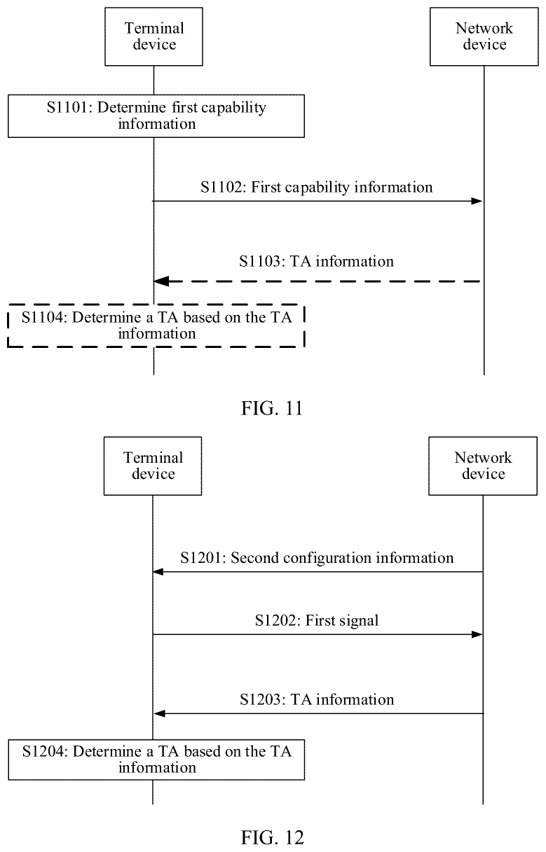

FIG. 11 is another diagram of a communication method according to this application. The method includes the following steps.
S1101: A terminal device determines first capability information.

In this embodiment, the terminal device determines the first capability information in step S1101, where the first capability information indicates a TA time synchronization capability of the terminal device.
S1102: The terminal device sends the first capability information.

In this embodiment, the terminal device sends the first capability information in step S1102, and correspondingly, a network device receives the first capability information in step S1102.

It should be noted that for implementation of the first capability information, refer to the foregoing step S702 and related content shown in FIG. 9, and a corresponding technical effect is implemented. Details are not described herein again.

In a possible implementation, the method further includes: A first network device sends the first capability information to a second network device.

Specifically, the first network device may further send, to the second network device, the first capability information indicating the TA tracking capability of the terminal device. In other words, information about the TA time synchronization capability of the terminal device may be transmitted between different network devices, so that after the terminal device is handed over to another network device, the another network device can also obtain corresponding capability information.

In a possible implementation, a first signal includes an SRS or a preamble (preamble).
S1103: The network device sends TA information.

In this embodiment, the network device sends the TA information in step S1203, and correspondingly, the terminal device receives the TA information in step S1203.
S1104: The terminal device determines a TA based on the TA information.

In this embodiment, the network device sends the TA information in step S1103, and correspondingly, the terminal device receives the TA information in step S1103.

It should be noted that, for a receiving and sending process of the TA information and the first signal used to determine the TA information in step S1103 and step S1104, refer to the implementation shown in FIG. 7, and a corresponding technical effect is implemented. Details are not described herein again.

Based on the foregoing technical solution, the first capability information sent by the terminal device indicates the TA time synchronization capability of the terminal device, so that the network device can determine the TA time synchronization capability of the terminal device based on the first capability information. In other words, the network device may determine capability information of open-loop TA adjustment of the terminal device based on the first capability information. In other words, the network device may use the first capability information as one of bases for whether scheduling the terminal device to perform closed-loop TA adjustment. Therefore, the network device can subsequently use information about the TA time synchronization capability sent by the terminal device as one of scheduling bases for closed-loop TA adjustment, to reduce overheads caused by performing closed-loop TA adjustment by a terminal device with a strong TA time synchronization capability, and enable a terminal device with a weak TA time synchronization capability to perform closed-loop TA adjustment in time.

In addition, step S1103 and step S1104 are optional steps, and may not be performed. For example, when the first capability information received by the network device in step S1102 indicates that the terminal device has a good information calibration capability, to be specific, the network device determines that an error corresponding to open-loop TA adjustment performed by the terminal device is less than a threshold, closed-loop TA adjustment does not need to be triggered, that is, step S1103 and step S1104 do not need to be performed.

FIG. 12 is another diagram of a communication method according to this application. The method includes the following steps.
S1201: A network device sends second configuration information.

In this embodiment, the network device sends the second configuration information in step S1201, and correspondingly, a terminal device receives the second configuration information in step S1201. The second configuration information includes time domain information that carries a first signal. In addition, the time domain information that carries the first signal includes a first parameter, and the first parameter is associated with a time interval between different transmission opportunities.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and the network device.

In an implementation example, after step S1201, the terminal device needs to determine, in the following manner, a time domain location that carries the first signal:

$$⌊ n \cdot {2}^{\frac{{μ}_{SRS}}{{μ}_{PDCCH}}} ⌋ + k + {k}_{offset} + {k}_{BH} .$$

n is a sequence number of a slot (slot) triggered when the terminal device receives the first signal.
k is the second parameter, and is a scheduling time offset of the first signal configured by the upper layer.
k_{offest} is the third parameter, and is an additional offset introduced in a 3GPP R16/R17 NTN scenario, and a corresponding time length needs to be greater than a round trip delay in the NTN scenario.
k_{BH} is the first parameter, and is an offset that is introduced in this embodiment and that is related to a time interval between beam hopping.

Therefore, an uplink scheduling offset of the first signal is further extended, and an additional extension amount is related to a time interval between two times of beam hopping for coverage, so that the scheduled first signal can arrive at the network device slightly earlier than a next time of beam hopping for downlink coverage. Based on the first parameter in the foregoing implementation, the first signal is scheduled within time of current beam hopping for coverage, and time at which the terminal device actually sends the first signal in subsequent step S1202 is slightly earlier than the next time of beam hopping for downlink coverage.
S1202: The terminal device sends the first signal.

In this embodiment, the terminal device sends the first signal in step S1202, and correspondingly, the network device receives the first signal in step S1202. The first signal is used to determine TA information.
S1203: The network device sends the TA information.

In this embodiment, the network device sends the TA information in step S1203, and correspondingly, the terminal device receives the TA information in step S1203.
S1204: The terminal device determines a TA based on the TA information.

In this embodiment, after the terminal device receives the TA information in step S1203, the terminal device determines the TA between the terminal device and the network device based on the TA information in step S1204, where the TA is used for data transmission after a time domain start location corresponding to time domain information of a first transmission opportunity.

It should be noted that, for a processing process of the first signal and the TA information in step S1202 to step S1204, refer to the implementation shown in FIG. 7, and a corresponding technical effect is implemented. Details are not described herein again.

Based on the foregoing technical solution, the second configuration information received by the terminal device includes the time domain information that carries the first signal, and the time domain information that carries the first signal includes the first parameter associated with the time interval between the different transmission opportunities, so that the terminal device sends the first signal based on the second configuration information. The first parameter may enable the network device to schedule the first signal within coverage time of a transmission opportunity, and enable time at which the terminal device actually sends the first signal to be slightly earlier than coverage time of a next transmission opportunity. Therefore, closed-loop TA adjustment of the terminal device is completed at (or before) a time domain start location of the next transmission opportunity, and after the time domain start location corresponding to the time domain information of the first transmission opportunity, the terminal device communicates with the network device based on the TA determined based on the TA information. In other words, when transmission opportunities of the terminal device are discontinuous, the terminal device performs, after a time domain start location corresponding to time domain information of the transmission opportunity, data transmission with the network device based on the TA determined based on the TA information, to reduce TA error accumulation caused by an open-loop adjustment manner, reduce intersymbol interference of an uplink signal, and improve stability of a communication system.

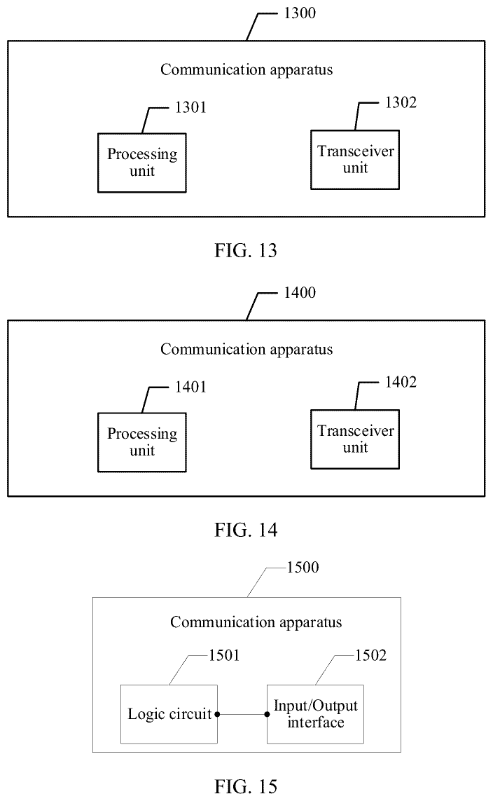

Refer to FIG. 13. An embodiment of this application provides a communication apparatus 1300. The communication apparatus 1300 may implement functions of the terminal device in the foregoing method embodiment, and therefore can also implement beneficial effects of the foregoing method embodiment. In this embodiment of this application, the communication apparatus 1300 may be the terminal device, or may be an integrated circuit, an element, or the like in the terminal device, for example, a chip. In the following embodiment, an example in which the communication apparatus 1300 is the terminal device is used for description.

In a possible implementation, when the apparatus 1300 is configured to perform the method performed by the terminal device in the foregoing embodiment, the apparatus 1300 includes a processing unit 1301 and a transceiver unit 1302.

The transceiver unit 1302 is configured to obtain first configuration information, where the first configuration information includes time domain information of a first transmission opportunity.

The transceiver unit 1302 is further configured to send a first signal, where the first signal is used to determine timing advance TA information.

The transceiver unit 1302 is further configured to obtain the TA information.

The processing unit 1301 is configured to determine a TA between the terminal device and a network device based on the TA information, where the TA is used for data transmission after a time domain start location corresponding to the time domain information of the first transmission opportunity.

In a possible implementation, the transceiver unit 1302 is further configured to obtain second configuration information, where the second configuration information includes time domain information that carries the first signal.

In a possible implementation, the transceiver unit 1302 is further configured to send first capability information, where the first capability information indicates a TA time synchronization capability of the terminal device.

In a possible implementation, the processing unit 1301 is specifically configured to:
after determining that a difference between a time domain location corresponding to the time domain information of the first transmission opportunity and a time domain location corresponding to time domain information of a second transmission opportunity is greater than a threshold, determine the TA between the terminal device and the network device based on the TA information, where
the second transmission opportunity is a transmission opportunity at an adjacent time domain location of the first transmission opportunity.

In a possible implementation,
the transceiver unit 1302 is further configured to obtain first indication information, where the first indication information indicates a first time period.

When the processing unit 1301 determines that a current moment falls within the first time period, the transceiver unit 1302 sends the first signal.

In a possible implementation, the difference between the time domain location corresponding to the time domain information of the first transmission opportunity and the time domain location corresponding to the time domain information of the second transmission opportunity includes any one of the following:
a difference between a start moment of the time domain location corresponding to the time domain information of the first transmission opportunity and a start moment of the time domain location corresponding to the time domain information of the second transmission opportunity;
a difference between an end moment of the time domain location corresponding to the time domain information of the first transmission opportunity and an end moment of the time domain location corresponding to the time domain information of the second transmission opportunity;
a difference between an end moment of the time domain location corresponding to the time domain information of the first transmission opportunity and a start moment of the time domain location corresponding to the time domain information of the second transmission opportunity; or
a difference between a start moment of the time domain location corresponding to the time domain information of the first transmission opportunity and an end moment of the time domain location corresponding to the time domain information of the second transmission opportunity.

In a possible implementation, the first configuration information further includes at least one of frequency domain information of the first transmission opportunity and polarization information of the first transmission opportunity.

In a possible implementation, the first indication information includes at least one of a start moment of the first time period, an end moment of the first time period, and duration of the first time period.

In a possible implementation, the first signal includes a sounding reference signal SRS or a preamble preamble.

In a possible implementation, when the apparatus 1300 is configured to perform the method performed by the terminal device in the foregoing embodiment, the apparatus 1300 includes a processing unit 1301 and a transceiver unit 1302.

The processing unit 1301 is configured to determine first capability information, where the first capability information indicates a TA time synchronization capability of the terminal device.

The transceiver unit 1302 is configured to send the first capability information.

In a possible implementation,
the transceiver unit 1302 is further configured to obtain second configuration information, where the second configuration information includes time domain information that carries a first signal.

The transceiver unit 1302 is further configured to send the first signal based on the second configuration information, where the first signal is used to determine TA information.

The transceiver unit 1302 is further configured to obtain the TA information.

The processing unit 1301 is further configured to determine a TA between the terminal device and a network device based on the TA information, where the TA is used for data transmission after a time domain start location corresponding to time domain information of a first transmission opportunity.

In a possible implementation, when the apparatus 1300 is configured to perform the method performed by the terminal device in the foregoing embodiment, the apparatus 1300 includes a processing unit 1301 and a transceiver unit 1302.

The transceiver unit 1302 is configured to obtain second configuration information, where the second configuration information includes time domain information that carries a first signal, the first signal is used to determine timing advance TA information, the time domain information that carries the first signal includes a first parameter, and the first parameter is associated with a time interval between different transmission opportunities.

The processing unit 1301 is configured to determine the first signal based on the second configuration information.

The transceiver unit 1302 is further configured to send the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between the terminal device and a network device.

It should be noted that, for content such as an information execution process of the units in the communication apparatus 1300, refer to the descriptions in the foregoing method embodiment of this application. Details are not described herein again.

Refer to FIG. 14. An embodiment of this application provides a communication apparatus 1400. The communication apparatus 1400 may implement functions of the network device in the foregoing method embodiment, and therefore can also implement beneficial effects of the foregoing method embodiment. In this embodiment of this application, the communication apparatus 1400 may be the network device, or may be an integrated circuit, an element, or the like in the network device, for example, a chip. In the following embodiment, an example in which the communication apparatus 1400 is the network device is used for description.

In a possible implementation, when the apparatus 1400 is configured to perform the method performed by the network device in the foregoing embodiment, the apparatus 1400 includes a processing unit 1401 and a transceiver unit 1402.

The transceiver unit 1402 is configured to send first configuration information, where the first configuration information includes time domain information of a first transmission opportunity.

The transceiver unit 1402 is further configured to obtain a first signal, where the first signal is used to determine timing advance TA information.

The processing unit 1401 is configured to determine the TA information based on the first signal.

The transceiver unit 1402 is further configured to send the TA information, where the TA information is used to determine a TA between a terminal device and the network device, and the TA is used for data transmission after a time domain start location corresponding to the time domain information of the first transmission opportunity.

In a possible implementation, the transceiver unit 1402 is further configured to send second configuration information, where the second configuration information includes time domain information that carries the first signal.

In a possible implementation, the transceiver unit 1402 is further configured to obtain first capability information, where the first capability information indicates a TA time synchronization capability of the terminal device.

The transceiver unit 1402 is further configured to send the second configuration information based on the first capability information.

In a possible implementation, the transceiver unit 1402 is further configured to send first indication information, where the first indication information indicates a first time period.

In a possible implementation,
the processing unit 1401 is further configured to determine a difference between a time domain location corresponding to the time domain information of the first transmission opportunity and a time domain location corresponding to time domain information of a second transmission opportunity, where the second transmission opportunity is a transmission opportunity at an adjacent time domain location of the first transmission opportunity.

When the processing unit 1401 determines that the difference is greater than a threshold, the transceiver unit 1402 sends the TA information.

In a possible implementation, the difference between the time domain location corresponding to the time domain information of the first transmission opportunity and the time domain location corresponding to the time domain information of the second transmission opportunity includes any one of the following:
a difference between a start moment of the time domain location corresponding to the time domain information of the first transmission opportunity and a start moment of the time domain location corresponding to the time domain information of the second transmission opportunity;
a difference between an end moment of the time domain location corresponding to the time domain information of the first transmission opportunity and an end moment of the time domain location corresponding to the time domain information of the second transmission opportunity;
a difference between an end moment of the time domain location corresponding to the time domain information of the first transmission opportunity and a start moment of the time domain location corresponding to the time domain information of the second transmission opportunity; or
a difference between a start moment of the time domain location corresponding to the time domain information of the first transmission opportunity and an end moment of the time domain location corresponding to the time domain information of the second transmission opportunity.

In a possible implementation, the first configuration information further includes at least one of frequency domain information of the first transmission opportunity and polarization information of the first transmission opportunity.

In a possible implementation, the first indication information includes at least one of a start moment of the first time period, an end moment of the first time period, and duration of the first time period.

In a possible implementation, the first signal includes a sounding reference signal SRS or a preamble preamble.

In a possible implementation, when the apparatus 1400 is configured to perform the method performed by the network device in the foregoing embodiment, the apparatus 1400 includes a processing unit 1401 and a transceiver unit 1402.

The transceiver unit 1402 is configured to obtain first capability information, where the first capability information indicates a TA tracking capability of a terminal device.

The transceiver unit 1402 is further configured to send second configuration information based on the first capability information, where the second configuration information includes time domain information that carries a first signal.

The transceiver unit 1402 is further configured to obtain the first signal based on the second configuration information, where the first signal is used to determine TA information.

The processing unit 1402 is configured to determine the TA information, where the TA information is used to determine a TA between the terminal device and the network device.

The transceiver unit 1402 is further configured to send the TA information.

In a possible implementation,
the transceiver unit 1402 is further configured to send the first capability information to a second network device.

In a possible implementation, when the apparatus 1400 is configured to perform the method performed by the network device in the foregoing embodiment, the apparatus 1400 includes a processing unit 1401 and a transceiver unit 1402.

The processing unit 1401 is configured to determine second configuration information, where the second configuration information includes time domain information that carries a first signal, and the first signal is used to determine timing advance TA information.

The transceiver unit 1402 is configured to send the second configuration information, where the time domain information that carries the first signal includes a first parameter, and the first parameter is associated with a time interval between different transmission opportunities.

The transceiver unit 1402 is further configured to obtain the first signal.

Optionally, the time domain information that carries the first signal further includes a second parameter, and the second parameter indicates an SRS scheduling time offset configured by an upper layer.

Optionally, the time domain information that carries the first signal further includes a third parameter, and the third parameter is associated with a round trip delay between a terminal device and the network device.

It should be noted that, for content such as an information execution process of the units in the communication apparatus 1400, refer to the descriptions in the foregoing method embodiment of this application. Details are not described herein again.

FIG. 15 is another diagram of a structure of a communication apparatus 1500 according to this application. The communication apparatus 1500 includes at least an input/output interface 1502. The communication apparatus 1500 may be a chip or an integrated circuit.

Optionally, the communication apparatus further includes a logic circuit 1501.

The transceiver unit 1302 shown in FIG. 13 (or the transceiver unit 1402 shown in FIG. 14) may be a communication interface. The communication interface may be the input/output interface 1502 in FIG. 15. The input/output interface 1502 may include an input interface and an output interface. Alternatively, the communication interface may be a transceiver circuit, and the transceiver circuit may include an input interface circuit and an output interface circuit.

Optionally, when the communication apparatus 1500 is configured to implement the method implemented by the terminal device in the foregoing embodiment, the input/output interface 1502 is configured to input first configuration information, the input/output interface 1502 may be further configured to output a first signal, the input/output interface 1502 may be further configured to input TA information to obtain first information, and the logic circuit 1501 may be configured to determine a TA based on the TA information. The logic circuit 1501 and the input/output interface 1502 may further perform other steps performed by the terminal device in any one of the foregoing embodiments, and implement corresponding beneficial effects. Details are not described herein again.

Optionally, when the communication apparatus 1500 is configured to implement the method implemented by the network device in the foregoing embodiment, the input/output interface 1502 is configured to output first configuration information, the input/output interface 1502 may be further configured to input a first signal, the logic circuit 1501 may be configured to determine TA information based on the first signal, and the input/output interface 1502 may be further configured to output the TA information. The logic circuit 1501 and the input/output interface 1502 may further perform other steps performed by the network device in any one of the foregoing embodiments, and implement corresponding beneficial effects. Details are not described herein again.

In a possible implementation, the processing unit 1301 shown in FIG. 13 (or the processing unit 1401 shown in FIG. 14) may be the logic circuit 1501 in FIG. 15.

Optionally, the logic circuit 1501 may be a processing apparatus, and some or all functions of the processing apparatus may be implemented by software. Some or all functions of the processing apparatus may be implemented by software.

Optionally, the processing apparatus may include a memory and a processor. The memory is configured to store a computer program, and the processor reads and executes the computer program stored in the memory, to perform corresponding processing and/or steps in any method embodiment.

Optionally, the processing apparatus may include only the processor. The memory configured to store the computer program is located outside the processing apparatus, and the processor is connected to the memory through a circuit/wire, to read and execute the computer program stored in the memory. The memory and the processor may be integrated together, or may be physically independent of each other.

Optionally, the processing apparatus may be one or more chips or one or more integrated circuits. For example, the processing apparatus may be one or more field programmable gate arrays (field programmable gate arrays, FPGAs), application-specific integrated circuits (application-specific integrated circuits, ASICs), system on chips (system on chips, SoCs), central processor units (central processor units, CPUs), network processors (network processors, NPs), digital signal processors (digital signal processors, DSPs), micro controller units (micro controller units, MCUs), programmable logic devices (programmable logic devices, PLDs), other integrated chips, or any combination of the foregoing chips or processors.

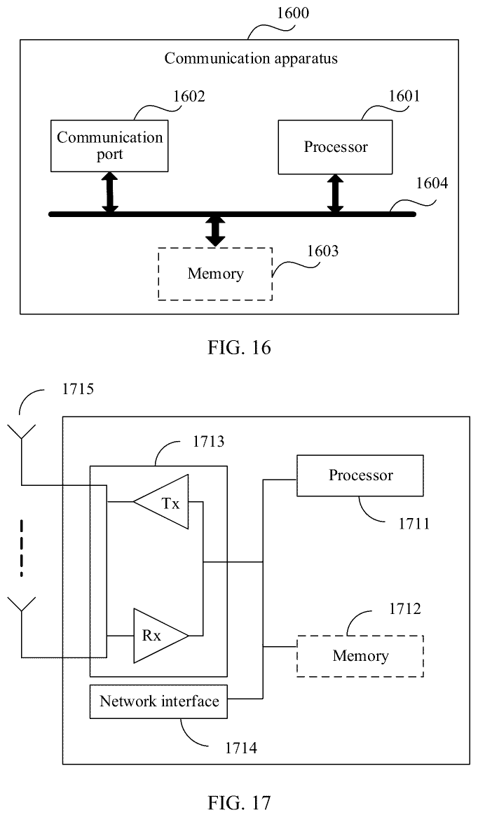

FIG. 16 shows a communication apparatus 1600 in the foregoing embodiment according to an embodiment of this application. The communication apparatus 1600 may be specifically a communication apparatus used as the terminal device in the foregoing embodiment. An example shown in FIG. 16 is that the terminal device is implemented by using the terminal device (or a component in the terminal device).

In a possible diagram of a logical structure of the communication apparatus 1600, the communication apparatus 1600 may include but is not limited to at least one processor 1601 and a communication port 1602.

Further, optionally, the apparatus may include at least one of a memory 1603 and a bus 1604. In this embodiment of this application, the at least one processor 1601 is configured to control an action of the communication apparatus 1600.

In addition, the processor 1601 may be a central processing unit, a general-purpose processor, a digital signal processor, an application-specific integrated circuit, a field programmable gate array or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiments. Details are not described herein again.

It should be noted that the communication apparatus 1600 shown in FIG. 16 may be specifically configured to implement the steps implemented by the terminal device in the foregoing method embodiment, and implement technical effects corresponding to the terminal device. For specific implementations of the communication apparatus shown in FIG. 16, refer to the descriptions in the foregoing method embodiment. Details are not described herein again.

FIG. 17 is a diagram of a structure of a communication apparatus 1700 in the foregoing embodiment according to an embodiment of this application. The communication apparatus 1700 may be specifically a communication apparatus used as the network device in the foregoing embodiment. An example shown in FIG. 17 is that the network device is implemented by using the network device (or a component in the network device). For the structure of the communication apparatus, refer to the structure shown in FIG. 17.

The communication apparatus 1700 includes at least one processor 1711 and at least one network interface 1714. Further, optionally, the communication apparatus includes at least one memory 1712, at least one transceiver 1713, and one or more antennas 1715. The processor 1711, the memory 1712, the transceiver 1713, and the network interface 1714 are connected to each other, for example, through a bus. In this embodiment of this application, the connection may include various types of interfaces, transmission lines, buses, or the like. This is not limited in this embodiment. The antenna 1715 is connected to the transceiver 1713. The network interface 1714 is configured to enable the communication apparatus to communicate with another communication device through a communication link. For example, the network interface 1714 may include a network interface between the communication apparatus and a core network device, for example, an SI interface. The network interface may include a network interface between the communication apparatus and another communication apparatus (for example, another network device or the core network device), for example, an X2 or Xn interface.

The processor 1711 is mainly configured to: process a communication protocol and communication data; control the entire communication apparatus; execute a software program; and process data of the software program. For example, the processor 1711 is configured to support the communication apparatus in performing the actions in embodiments. The communication apparatus may include a baseband processor and a central processing unit. The baseband processor is mainly configured to process the communication protocol and the communication data. The central processing unit is mainly configured to: control the entire terminal device, execute the software program, and process the data of the software program. Functions of the baseband processor and the central processing unit may be integrated into the processor 1711 in FIG. 17. A person skilled in the art may understand that the baseband processor and the central processing unit may each be an independent processor, and are interconnected by using a technology such as a bus. A person skilled in the art may understand that the terminal device may include a plurality of baseband processors to adapt to different network standards, and the terminal device may include a plurality of central processing units to enhance a processing capability of the terminal device, and components of the terminal device may be connected through various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of a software program, and the processor executes the software program to implement a baseband processing function.

The memory is mainly configured to store the software program and data. The memory 1712 may exist independently, and is connected to the processor 1711. Optionally, the memory 1712 and the processor 1711 may be integrated, for example, integrated into one chip. The memory 1712 can store program code for executing the technical solutions in embodiments of this application, and the processor 1711 controls the execution. Various types of executed computer program code may also be considered as drivers of the processor 1711.

FIG. 17 shows only one memory and one processor. In an actual terminal device, there may be a plurality of processors and a plurality of memories. The memory may also be referred to as a storage medium, a storage device, or the like. The memory may be a storage element on a same chip as the processor, that is, an on-chip storage element, or may be an independent storage element. This is not limited in embodiments of this application.

The transceiver 1713 may be configured to support receiving or sending of a radio frequency signal between the communication apparatus and the terminal, and the transceiver 1713 may be connected to the antenna 1715. The transceiver 1713 includes a transmitter Tx and a receiver Rx. Specifically, the one or more antennas 1715 may receive the radio frequency signal. The receiver Rx in the transceiver 1713 is configured to: receive the radio frequency signal from the antenna, convert the radio frequency signal into a digital baseband signal or a digital intermediate frequency signal, and provide the digital baseband signal or the digital intermediate frequency signal for the processor 1711, so that the processor 1711 further processes the digital baseband signal or the digital intermediate frequency signal, for example, performs demodulation processing and decoding processing. In addition, the transmitter Tx in the transceiver 1713 is further configured to: receive a modulated digital baseband signal or digital intermediate frequency signal from the processor 1711, convert the modulated digital baseband signal or digital intermediate frequency signal into a radio frequency signal, and send the radio frequency signal through the one or more antennas 1715. Specifically, the receiver Rx may selectively perform one-level or multi-level down frequency mixing and analog-to-digital conversion on the radio frequency signal, to obtain the digital baseband signal or the digital intermediate frequency signal. A sequence of down frequency mixing and analog-to-digital conversion may be adjusted. The transmitter Tx may selectively perform one-level or multi-level up frequency mixing and digital-to-analog conversion on the modulated digital baseband signal or digital intermediate frequency signal, to obtain the radio frequency signal. A sequence of up frequency mixing and digital-to-analog conversion is adjustable. The digital baseband signal and the digital intermediate frequency signal may be collectively referred to as a digital signal.

The transceiver 1713 may also be referred to as a transceiver unit, a transceiver machine, a transceiver apparatus, or the like. Optionally, a component configured to implement a receiving function in the transceiver unit may be considered as a receiving unit, and a component configured to implement a sending function in the transceiver unit may be considered as a sending unit. That is, the transceiver unit includes the receiving unit and the sending unit. The receiving unit may also be referred to as a receiver machine, an input interface, a receiving circuit, or the like, and the sending unit may be referred to as a transmitter machine, a transmitter, a transmitter circuit, or the like.

It should be noted that the communication apparatus 1700 shown in FIG. 17 may be specifically configured to implement the steps implemented by the network device in the foregoing method embodiment, and implement technical effects corresponding to the network device. For specific implementations of the communication apparatus 1700 shown in FIG. 17, refer to the descriptions in the foregoing method embodiment. Details are not described herein again.

An embodiment of this application further provides a computer-readable storage medium that stores one or more computer-executable instructions. When the computer-executable instructions are executed by a processor, the processor performs the method in the possible implementations of the terminal device in the foregoing embodiment.

An embodiment of this application further provides a computer-readable storage medium that stores one or more computer-executable instructions. When the computer-executable instructions are executed by a processor, the processor performs the method in the possible implementations of the network device in the foregoing embodiment.

An embodiment of this application further provides a computer program product (or referred to as a computer program) that stores one or more computers. When the computer program product is executed by a processor, the processor performs the method in the possible implementations of the terminal device.

An embodiment of this application further provides a computer program product that stores one or more computers. When the computer program product is executed by a processor, the processor performs the method in the possible implementations of the network device.

An embodiment of this application further provides a chip system. The chip system includes at least one processor, configured to support a communication apparatus in implementing functions in the foregoing possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the terminal device in the foregoing method embodiment.

An embodiment of this application further provides a chip system. The chip system includes at least one processor, configured to support a communication apparatus in implementing functions in the foregoing possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the network device in the foregoing method embodiment.

An embodiment of this application further provides a communication system. A network system architecture includes the terminal device and the network device in any one of the foregoing embodiments.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit. When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a storage medium and includes several instructions for instructing a computer device (which may be a personal computer, a server, or a network device) to perform all or some of the steps of the method described in embodiments of this application. The storage medium includes any medium that can store program code, such as a USB flash drive, a removable hard disk, a read-only memory (ROM, Read-Only Memory), a random access memory (RAM, Random Access Memory), a magnetic disk, or an optical disc.

What is claimed is:

1. A communication method, applied in a terminal device comprising:
obtaining, first configuration information, wherein the first configuration information comprises time domain information of a first transmission opportunity;
sending, a first signal, wherein the first signal is used to determine timing advance (TA) information;
obtaining, the TA information; and
determining, a TA between the terminal device and a network device based on the TA information, wherein the TA is used for data transmission after a time domain start location corresponding to the time domain information of the first transmission opportunity.

2. The method according to claim 1, wherein before the sending, a first signal, the method further comprises:
obtaining, second configuration information, wherein the second configuration information comprises time domain information that carries the first signal.

3. The method according to claim 2, wherein before the obtaining, second configuration information, the method further comprises:
sending, first capability information, wherein the first capability information indicates a TA time synchronization capability of the terminal device.

4. The method according to claim 1, wherein the determining, by the terminal device, a TA between the terminal device and a network device based on the TA information comprises:
after the terminal device determines that a difference between a time domain location corresponding to the time domain information of the first transmission opportunity and a time domain location corresponding to time domain information of a second transmission opportunity is greater than a threshold, determining, the TA between the terminal device and the network device based on the TA information, wherein
the second transmission opportunity is a transmission opportunity at an adjacent time domain location of the first transmission opportunity.

5. The method according to claim 1, wherein before the sending, a first signal, the method further comprises:
obtaining, first indication information, wherein the first indication information indicates a first time period; and
when the terminal device determines that a current moment falls within the first time period, sending, the first signal.

6. A communication method, applied in a network device, comprising:
sending, first configuration information, wherein the first configuration information comprises time domain information of a first transmission opportunity;
obtaining, a first signal, wherein the first signal is used to determine timing advance (TA) information; and
sending, the TA information, wherein the TA information is used to determine a TA between a terminal device and the network device, and the TA is used for data transmission after a time domain start location corresponding to the time domain information of the first transmission opportunity.

7. The method according to claim 6, wherein before the obtaining, a first signal, the method further comprises:
sending, second configuration information, wherein the second configuration information comprises time domain information that carries the first signal.

8. The method according to claim 7, wherein the sending, second configuration information comprises:
receiving, first capability information, wherein the first capability information indicates a TA time synchronization capability of the terminal device; and
sending, the second configuration information based on the first capability information.

9. The method according to claim 6, wherein before the obtaining, a first signal, the method further comprises:
sending, first indication information, wherein the first indication information indicates a first time period.

10. The method according to claim 6, wherein the sending, the TA information comprises:
determining, a difference between a time domain location corresponding to the time domain information of the first transmission opportunity and a time domain location corresponding to time domain information of a second transmission opportunity, wherein the second transmission opportunity is a transmission opportunity at an adjacent time domain location of the first transmission opportunity; and
when the network device determines that the difference is greater than a threshold, sending, by the network device, the TA information.

11. A communication apparatus, comprising a transceiver unit and a processing unit, wherein
the transceiver unit is configured to obtain first configuration information, wherein the first configuration information comprises time domain information of a first transmission opportunity;
the transceiver unit is further configured to send a first signal, wherein the first signal is used to determine timing advance (TA) information;
the transceiver unit is further configured to obtain the TA information; and
the processing unit is configured to determine a TA between a terminal device and a network device based on the TA information, wherein the TA is used for data transmission after a time domain start location corresponding to the time domain information of the first transmission opportunity.

12. The apparatus according to claim 11, wherein the transceiver unit is further configured to obtain second configuration information, wherein the second configuration information comprises time domain information that carries the first signal.

13. The apparatus according to claim 12, wherein the transceiver unit is further configured to send first capability information, wherein the first capability information indicates a TA time synchronization capability of the terminal device.

14. The apparatus according to claim 11, wherein the processing unit is specifically configured to:
after determining that a difference between a time domain location corresponding to the time domain information of the first transmission opportunity and a time domain location corresponding to time domain information of a second transmission opportunity is greater than a threshold, determine the TA between the terminal device and the network device based on the TA information, wherein
the second transmission opportunity is a transmission opportunity at an adjacent time domain location of the first transmission opportunity.

15. The apparatus according to claim 11, wherein
the transceiver unit is further configured to obtain first indication information, wherein the first indication information indicates a first time period; and
when the processing unit determines that a current moment falls within the first time period, the transceiver unit sends the first signal.

16. A communication apparatus, comprising a transceiver unit and a processing unit, wherein
the transceiver unit is configured to send first configuration information, wherein the first configuration information comprises time domain information of a first transmission opportunity;
the transceiver unit is further configured to obtain a first signal, wherein the first signal is used to determine timing advance (TA) information;
the processing unit is configured to determine the TA information based on the first signal; and
the transceiver unit is further configured to send the TA information, wherein the TA information is used to determine a TA between a terminal device and a network device, and the TA is used for data transmission after a time domain start location corresponding to the time domain information of the first transmission opportunity.

17. The apparatus according to claim 16, wherein the transceiver unit is further configured to send second configuration information, wherein the second configuration information comprises time domain information that carries the first signal.

18. The apparatus according to claim 17, wherein the transceiver unit is further configured to obtain first capability information, wherein the first capability information indicates a TA time synchronization capability of the terminal device; and
the transceiver unit is further configured to send the second configuration information based on the first capability information.

19. The apparatus according to claim 16, wherein the transceiver unit is further configured to send first indication information, wherein the first indication information indicates a first time period.

20. The apparatus according to claim 16, wherein
the processing unit is further configured to determine a difference between a time domain location corresponding to the time domain information of the first transmission opportunity and a time domain location corresponding to time domain information of a second transmission opportunity, wherein the second transmission opportunity is a transmission opportunity at an adjacent time domain location of the first transmission opportunity; and
when the processing unit determines that the difference is greater than a threshold, the transceiver unit sends the TA information.
